(19) United States
(12) Patent Application Publication
(10) Pub. No.: US 2015/0252879 A1
(43) Pub. Date: Sep. 10, 2015

(54) SYNCHRONIZED SHIFT TRANSMISSION

(71) Applicant: VMT Technologies, LLC, Highland, UT (US)

(72) Inventor: Gary Lee, Lehi, UT (US)

(21) Appl. No.: 14/637,120

(22) Filed: Mar. 3, 2015

Related U.S. Application Data
(60) Provisional application No. 61/948,502, filed on Mar. 5, 2014.
(60) Provisional application No. 62/121,122, filed on Feb. 26, 2015.

(51) Int. Cl. F16H 9/12; F16H 9/14; F16H 9/10

(52) U.S. Cl. CPC F16H 9/125; F16H 9/10; F16H 9/14

(57) ABSTRACT

In one example, a portion of a transmission includes first and second sheave halves disposed on a shaft, one of which is movable along the shaft relative to the other sheave half. Three moon gears are disposed on a rotatable shaft attached to a first sled that moves along a slot defined in a sheave halve. An input shaft with a control gear is connected to the sheave halves. Three threaded shafts are provided, that each include a worm gear. The worm gear engages an index gear of a respective rotatable shaft on which a respective one of the moon gears is mounted, and each threaded shaft including a threaded shaft drive gear that engages the control gear. A shift controller is coupled to the input shaft and threaded shaft drive gears, and creates a difference in rotational speed between the input shaft and the threaded shaft drive gear.

### RELATED APPLICATIONS

The present application claims priority to, and the benefit of: U.S. Provisional Patent Application Ser. 61/948,502, entitled SYNCHRONIZED SHIFT TRANSMISSION, filed Mar. 5, 2014; and, U.S. Provisional Patent Application Ser. 62/121,122, entitled SYNCHRONIZED SHIFT TRANSMISSION, filed Feb. 26, 2015. All of the aforementioned applications are incorporated herein in their respective entireties by this reference.

### BACKGROUND

The present application relates to the field of transmission systems and related processes and components. More particularly, the present invention relates to methods, systems, sub-systems, assemblies, and components for providing substantially constant engagement between a load and prime mover during power transmission, and during changes of a relatively large number of gear ratios in relatively small increments.

### BRIEF DESCRIPTION OF THE DRAWINGS

To further clarify the aspects of embodiments of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an example embodiment;

FIG. 2 is an exploded view of the example of FIG. 1;

FIG. 3 includes various views of an example gun lock assembly;

FIG. 4 includes various detail and exploded views of an example gun lock assembly;

FIG. 5 is an exploded view of an example differential;

FIG. 6 is an exploded view of an example reduction gear;

FIG. 7 discloses details concerning examples of a sheave controller, indexer and synchronizer;

FIG. 8 is a detail view of an example embodiment disclosing details of a slot configuration and arrangement;

FIG. 9 is a side view of an example assembly that includes a sheave, a plurality of moon gears, and a driving member in the form of a chain;

FIG. 10 is an exploded view of an example spring loaded cylinder and worm as gear;

FIG. 10a is similar to FIG. 10 and further discloses an example shaft;

FIG. 11 (total of 3 sheets) discloses movement of an example moon gear before, during, and after a gear ratio change;

FIG. 12 discloses and example moon gear tooth profile;

FIG. 13 discloses various details concerning a sled, sheave, and slot;

FIG. 14a discloses aspects of an example continuously variable transmission (CVT);

FIG. 14b discloses aspects of an example universal transmission (UT) according to some embodiments of the invention;

FIG. 15a is a diagram illustrating aspects of the operational principles of the CVT of FIG. 14a;

FIG. 15b is a diagram illustrating aspects of operational principles of the UT of FIG. 14b;

FIG. 16 is a diagram of some example whole integer circles;

FIG. 17a illustrates an example of a raking condition;

FIG. 17b discloses of an arrangement where a raking condition has been eliminated or avoided;

FIG. 18 is a perspective view of a portion of an example embodiment of a transmission;

FIG. 19 is similar to FIG. 18 and additionally discloses an example embodiment of a shift controller;

FIG. 20 is an exploded view of an example embodiment of a shift controller;

FIG. 21 is a detail view of elements of an example shift controller;

FIG. 22 is a detail view of elements of an example sled assembly and related components;

FIG. 23 is a diagram disclosing aspects of sheave and sled operations and principles;

FIG. 24 discloses elements of example components for indexing of a moon gear;

FIGS. 25a and 25b are diagrams that disclose aspects of example tooth and a chain configuration and arrangement;

FIG. 26 is a diagram that discloses aspects of an example chain pin;

FIG. 27 is a diagram that discloses aspects of an example chain pin and associated principles;

FIG. 28 is a perspective view of an example belt that can be used in some embodiments of the invention;

FIG. 29 is a diagram of an example tensioner arrangement that can be used in some embodiments of the invention;

FIGS. 30a-30c disclose aspects of an example sheave and sled configuration and arrangement;

FIG. 31 is a graphical illustration of various synchronous linear relationships involving moon gears, indexing, and sheave rotation; and

FIG. 32 is a perspective view of an example embodiment that includes two sheaves.

### DESCRIPTION OF SOME EXAMPLE EMBODIMENTS

This disclosure relates to transmission systems. More particularly, the disclosure herein relates to transmission systems that can convey power from a source to a load using gear ratios that are changeable in very small, perhaps infinitely small, increments.

Reference will now be made to the drawings to describe various aspects of example embodiments of the invention. It is to be understood that the drawings are diagrammatic and schematic representations of such example embodiments, and are not limiting of the present invention. Moreover, while various drawings are provided at a scale that is considered functional for some embodiments, the drawings are not necessarily drawn to scale for all contemplated embodiments. No inference should therefore be drawn from the drawings as to any required scale.

In the following description, numerous specific details are set forth in order to provide a thorough understanding of the present invention. It will be obvious, however, to one skilled in the art that the present invention may be practiced without these specific details. In other instances, well-known aspects of transmission systems, including bearings, journals, manufacturing processes, and the like have not been described in particular detail in order to avoid unnecessarily obscuring aspects of the disclosed embodiments.

A. General

The disclosed embodiments may be usefully employed in connection with a variety of systems and devices, and in a variety of different applications. By way of illustration, but not limitation, embodiments disclosed herein may, but are not required to, be employed in connection with the systems and components disclosed in any of the following applications: U.S. Provisional Application Ser. 61/466,167, filed Mar. 22, 2011; U.S. Provisional Application Ser. 61/471,009, filed Apr. 1, 2011; U.S. application Ser. No. 13/427,354, filed Mar. 22, 2012; and, U.S. Provisional Application Ser. 61/775,307, filed Mar. 8, 2013. All of the aforementioned applications are incorporated herein in their respective entireties by this reference. Among other things, embodiments of the invention may replace or supplement, in whole or in part, any of the correction mechanisms disclosed in the aforementioned applications.

B. Overview

Embodiments of the disclosed synchronized shift design are operable to, among other things, shift from any number of prime whole integers in any number of rotations of the input. One aspect of at least some embodiments of the invention is that, with reference to the example of a driving, or driven, member in the form of a chain, every three links of the chain (which represents prime whole integers) are divided into as many divisions as the particular use or application warrants. As used herein, these divisions refer to the number of partial tooth corrections made per prime integer shift. Another aspect of at least some embodiments of the invention is that it is possible to make X number of corrections in Y number of revolutions. This is due at least in part to the fact that the driving and driven members are always constantly engaged with each other, and the engine and the load are never disconnected from each other. These options can be applied to manipulate the torque loads on the entire drive train. The popular paradigm in vehicle design is to shift fast and to create more ratios. Embodiments of the present invention however contemplate that time between shifts is a variable used at the discretion of the engineer in the design of the transmission. While shifting from one operating ratio, or gear ratio, to the next desired operating ratio, as many output revolutions as needed can be used, and transitions between gear ratios can be made in very small, perhaps infinitely small, increments of ratio change.

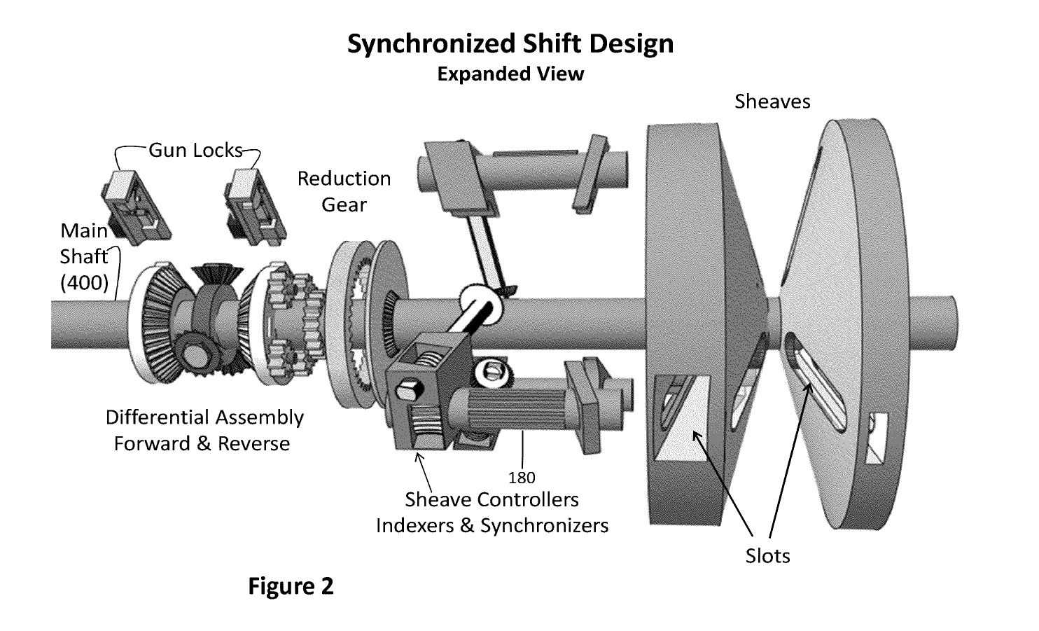

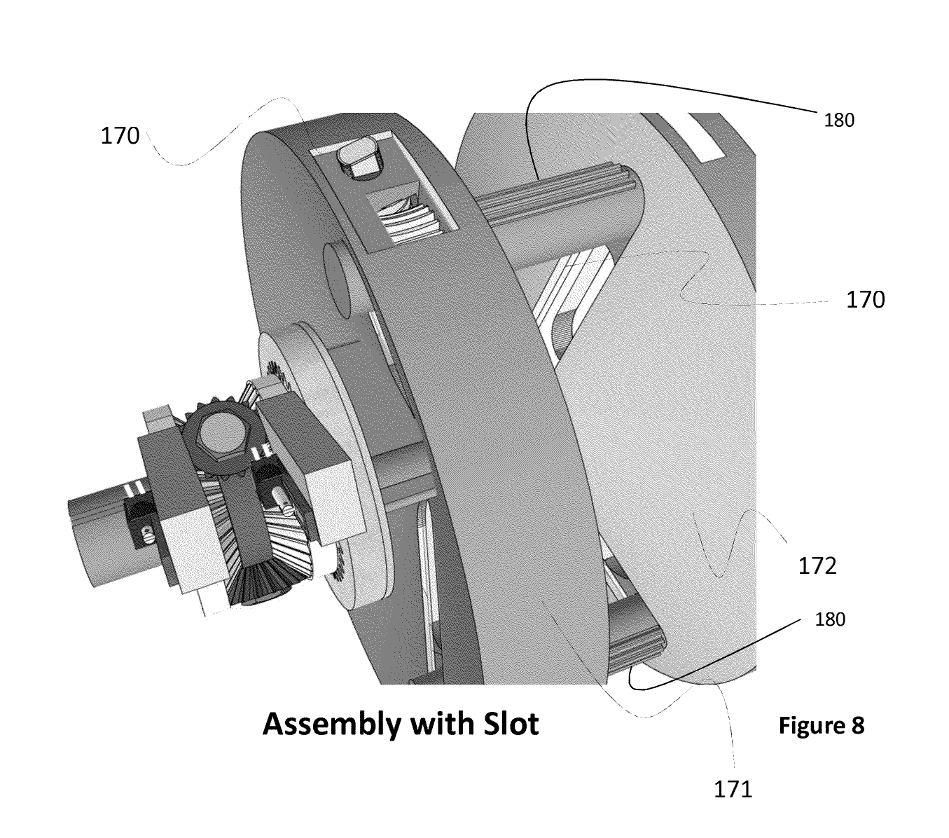

As used herein, a shift is defined as the radial movement of the moon gears 180, which may comprise an entire gear or only a portion of a gear (see, e.g., FIGS. 2 and 8), from one prime whole integer to the next prime integer. At each prime whole integer, a tooth of the moon gear 180 is lined up radially with the sheave shaft. The shift does not have to stop at every prime whole integer, but can travel through as many prime integers as the conditions of the vehicle warrants.

There are three elements associated with this technology that, once engineered for an application, remain consistently in a defined ratio relationship. During a shift, the three elements are the ratio between: Number one: Angular rotation of the sheave (see 171 and 172), Number two: The radius of the belt (or sled); and, Number three: The angular correction of the moon gears 180. In connection with the foregoing, example methods of controlling sheave movement are also disclosed.

C. Detailed Description

For purposes of this explanation, it is assumed that, initially, an engine is running and the transmission is engaged at some ratio. The following discussion tracks the sequence of parts from the start of a shift to the end of the shift.

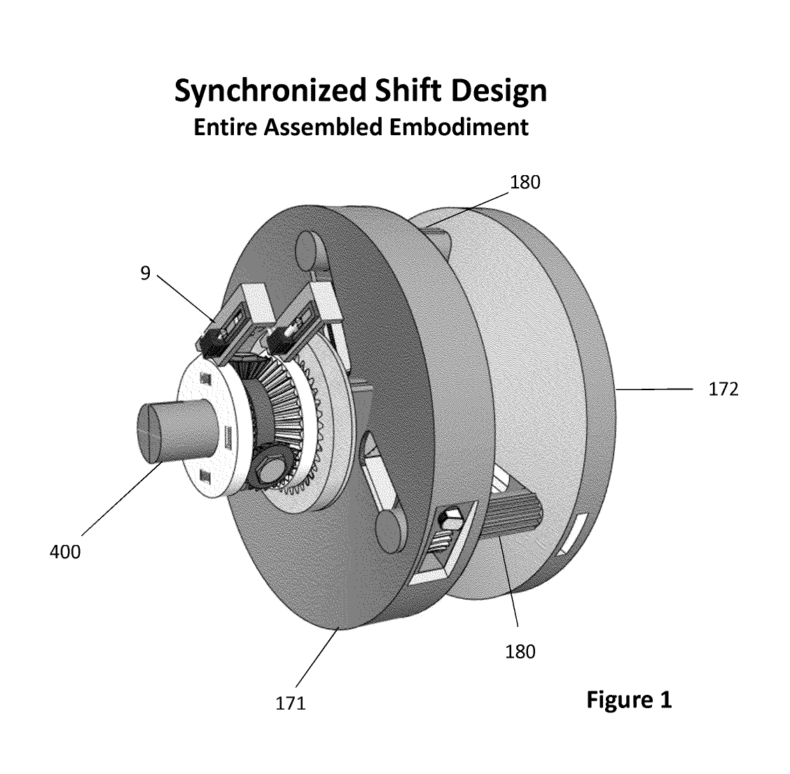

FIGS. 1-2 provide a view of one example embodiment of the invention.

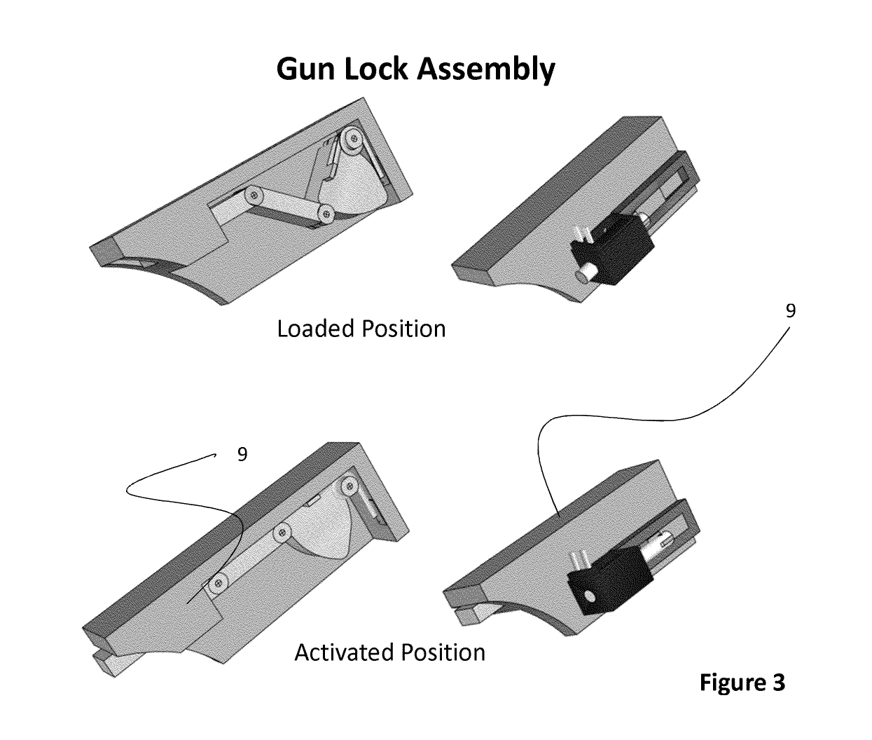

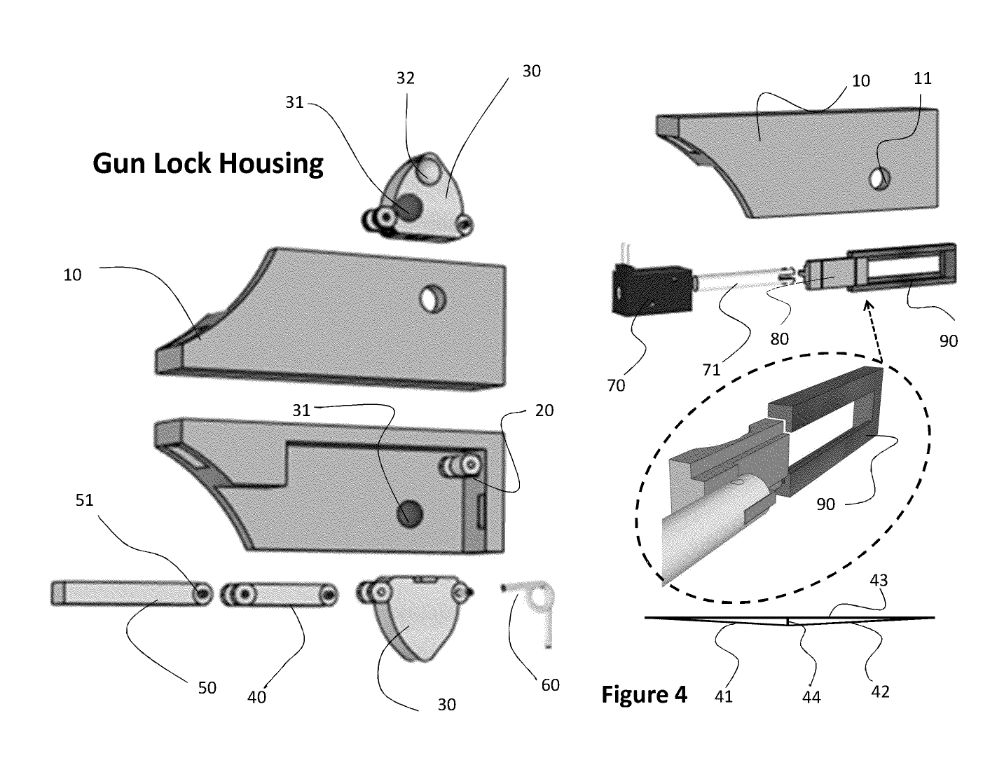

The first step in creating the shift begins with the gun locks. There are two gun lock assemblies, one for an upshift and the other for a down shift. When the need for a change in ratio is sensed or desired, a solenoid assembly, which is part of the gun lock (9), is utilized to control the shift. The solenoid (70) would place the gun lock in the activated position (FIG. 3). The solenoid (70) in (FIG. 4) is attached to the gun lock housing (10) and its solenoid plunger (71) is connected to a ball ramp slide (80). The ball ramp slide (80) is constrained to move along the housing surface by a T-slot guide (90). The ball ramp slide (80) is flat on both ends that contact the housing with a cammed void in the center for unlocking and receiving the ball (31). The cam surfaces force the ball (31) through the ball hole (11).

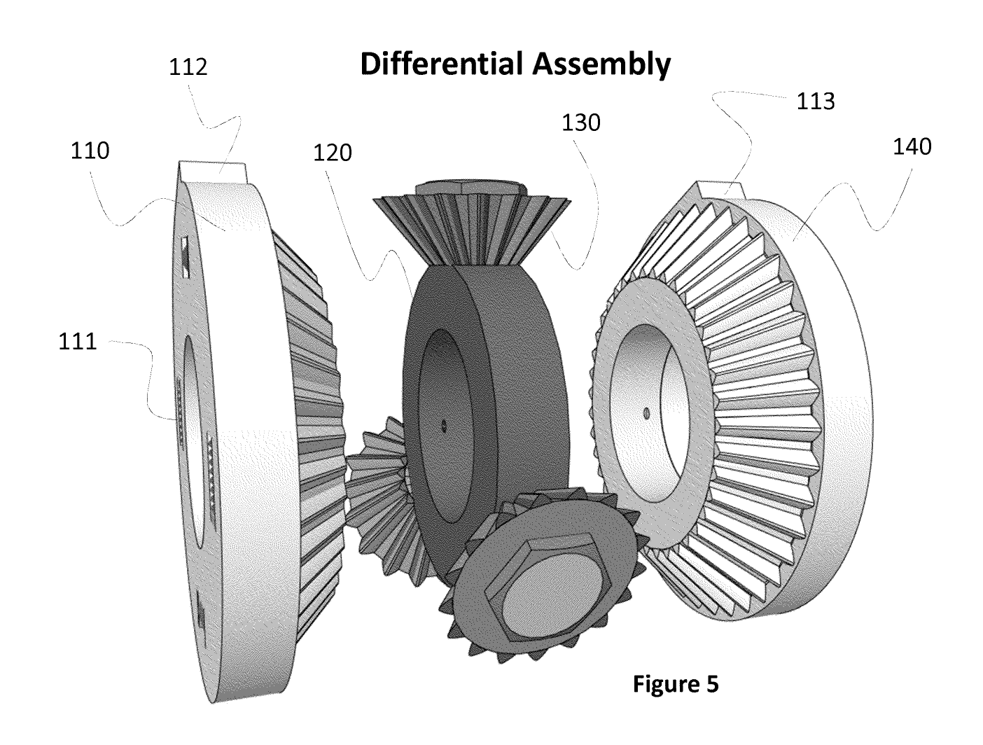

When the solenoid (70) (FIG. 4) is activated, the magnetic field quickly moves the solenoid plunger (71) outward. Connected to the end of the solenoid plunger (71) is the ball ramp slide (80). The ball ramp slide (80) holds the ball (31) in the ball sphere (32) such that the loaded ball link spring (60) causes the ball link (30) to remain loaded. As the ball ramp slide (80) extends outward, the ball (31) is released out of the ball sphere (32) and into the void cut out of the underside of the ball ramp slide (80). This releases the ball link (30) and allows the ball link spring (60) to push it to the top of the gun lock housing (10). This action forces the stop link (40) to push and almost fully extend the stop (50). When the ball link (30) snaps into position, it lines up the ball sphere (32) and the ball ramp slide (80) ramps the ball (31) until it moves into the ball sphere (32). The ball link (30) is now locked into the extended position. The stop (50) is now prepared to contact either the stop side gear striker (113) or the doubler side gear striker (112). (FIG. 5) and stop the rotation of the desired upshift or downshift stop side gear (140) or doubler side gear (110). The pivots, such as housing pivot (20) (FIG. 4) and stop pivot (51), are designed with maximum surface contact.

Again in FIG. 4, it is disclosed what is meant by “almost fully” extending the stop (50). If the links are fully extended into a straight line, see the line (43), about 100% of the force received by the controller would be transmitted into the gun lock housing (10) which is fixed to the transmission housing. If the stop link (40) and the ball link (30) are positioned as illustrated by the line (41) and line (42), respectively, a right-angle triangle is created. Half of the line (43) and the line (44) would defined the co-sine and sine of the angle. The force represented by the sine of the angle would have to overcome the tension of the ball link spring (60) and reload the ball link (30). As will be apparent from the illustration, almost all of the force would be constrained by the gun lock housing (10) and a small fraction would have to be constrained by the gun lock (9) system.

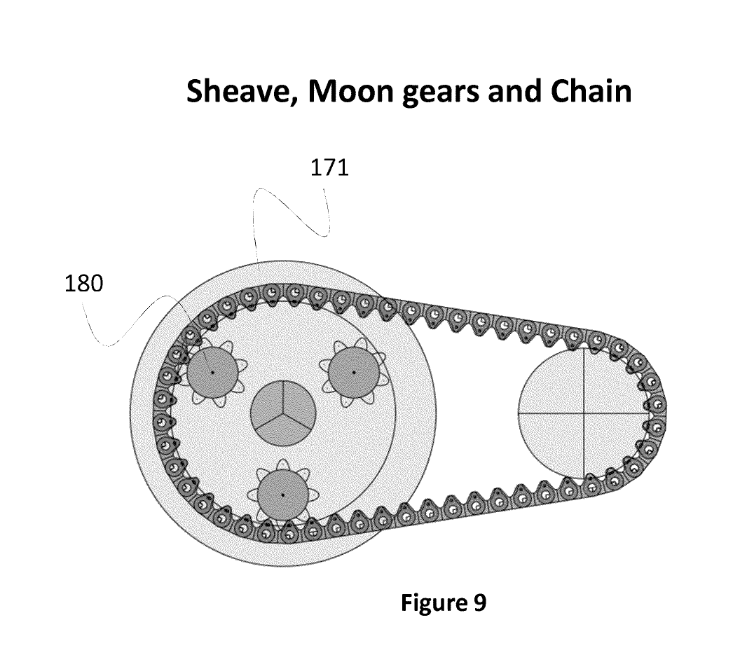

After an engineered number of revolutions of the input, while a side gear (110 or 140) has been stopped by the stop (50), the adjustable sheave (172) and fixed primary sheave (171) (see FIG. 8) will reach a whole integer circle and when the moon gear (180) (see FIG. 9) tooth lines up with its radial line the polarity of the solenoid (70) will be reversed and the solenoid plunger (71) will start to retract. The ball (31) which was locked in the ball sphere (32) will be released to move once again into the ball ramp slide (80) void. The force acting against the stop (50), by one of the side gear strikers (112 or 113), is now free to reload the system and compress the ball link spring (60). As the ball link spring (60) becomes fully compressed the ball ramp slide (80) forces the ball (31) back into ball sphere (32). The solenoid plunger (71) and ball ramp slide (80) are back in their original positions ready to shift again on command.

The differential assembly (FIG. 5) includes a stop side gear (110) and the doubler side gear (140), which are journaled for rotation about and independent of the main input shaft (400) (see FIGS. 2 & 7) and both side gears also engage each of the three spider gears (130). The spider gears (130) are bolted to the main shaft (400) by means of the spider gear ring (120). Additionally, each side gear contains four compression springs (111) that damper the torque spike associated with the sudden stop of the side gear.

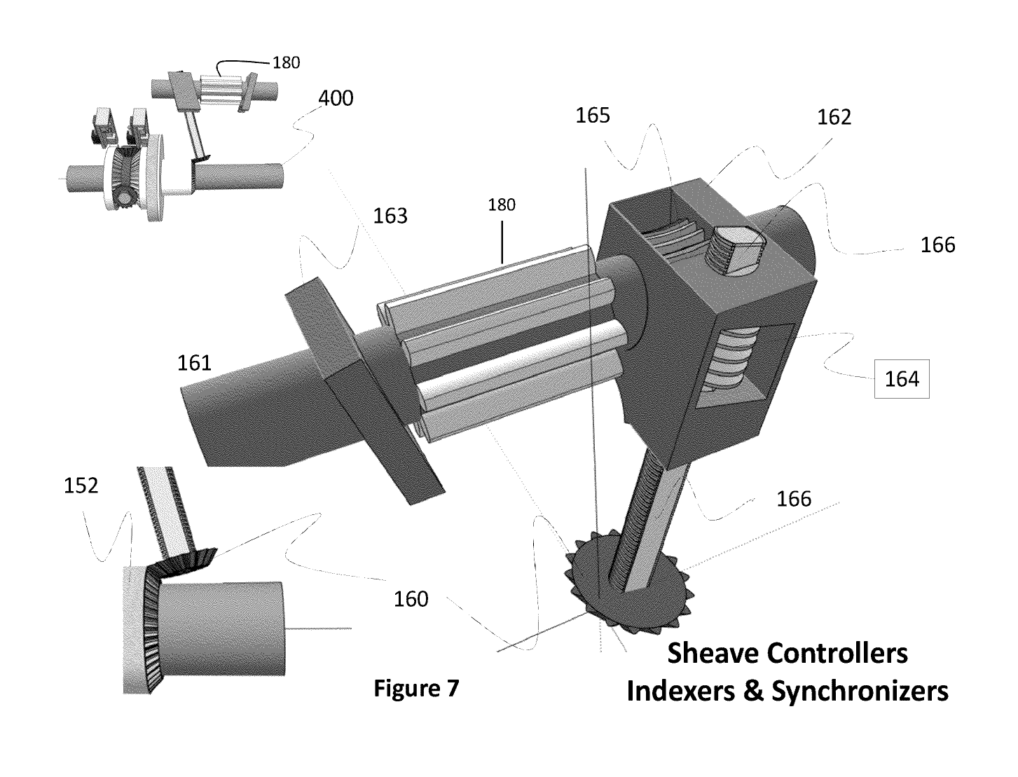

The purpose of the differential is to provide relative and equal forward and reverse or faster and slower rotation in relation to the sheave. This controls the threaded splined shaft (161) (see FIG. 7, discussed below) which also controls: 1. Movement of the sheaves toward, and away from, each other; 2. the inward and outward movement of the sled; and, 3. the indexing rotation of the moon gear.

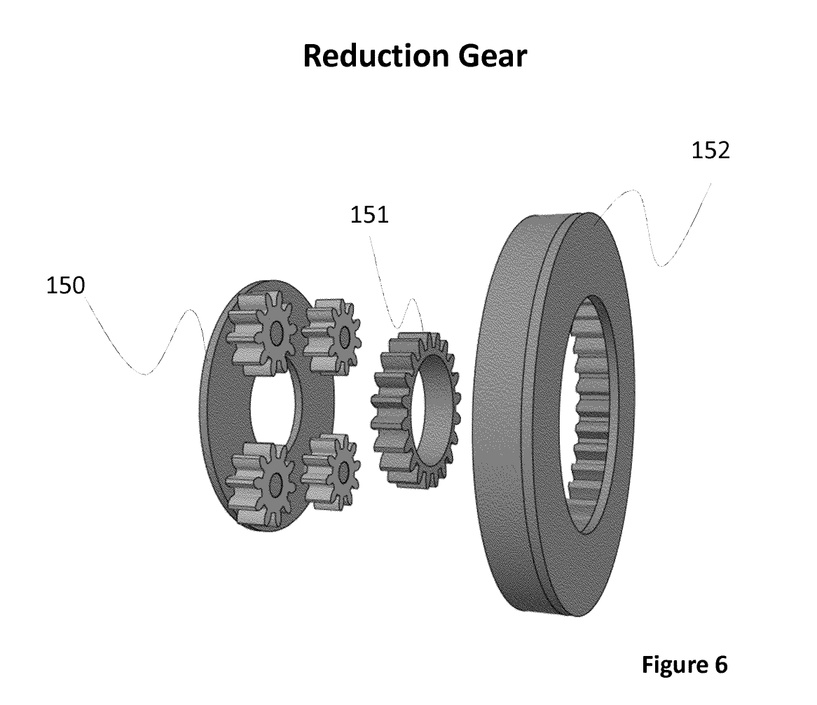

The reduction gear (FIG. 6) is an optional feature of the design. It would be used at the discretion of the engineer and the application for which the transmission was to be used. It is conceivable that a slower shift could be desirable. Because the load and engine are always constantly engaged and never disconnect the engine from the load, this option can be applied to limit torque loads on the entire drive train.

The sun gear 151 (FIG. 6) would be attached to the main shaft (400), the planet carrier (150) would be attached to the speed doubler side gear (140) and the ring gear (152) would be attached to the beveled gear (160) (FIG. 7) of the threaded spline shaft (161).

The threaded spline shaft (161) is received into the primary sled (162) by matching thread (not shown). The primary sled (162 and sled (163) are constrained for movement within a slot (170) (FIG. 8). As the threaded spline shaft (161) rotates, it raises and lowers the primary sled (162) which force the primary sheave (171) and sheave (172) to move together and apart, as applicable. The primary sheave (171) remains fixed in place with the differential and reduction gears while sheave (172) moves together and apart from primary sheave (171).

The second function of the threaded spline shaft (161) (FIG. 7) is to rotate worm gear (164). The rotation of worm gear (164) by its engagement with the moon indexer gear (165) corrects the moon gear teeth for the partial integer engagement. The threads per centimeter of the shaft and the threads per centimeter of the worm gear are engineered for a synchronous increase in radius, indexing of the moon, and inward and outward movement of the sheave. The shaft(s) 161 thus provides, or at least facilitates, three different functions.

In general, a shift requires the increase or decrease of the radius between the moon gears (180) (FIG. 9) and the center of the shaft of the primary sheave (171). This requires the 120 degree separation of the three moons to pass through possibly several rotations in which the moon gears (180) would collide with partial integers of the chain until the moon gear reached the next whole integer, referred to herein as a prime circle. The synchronizing characteristics that have been explained provide a correction of the moon gear (180) such that a corrected engagement, i.e., a non-partial tooth engagement, always takes place.

Some of the characteristics of these aspects of embodiments of the invention are that the desired shift speed is coordinated between sheave movement, radius of the chain, and correction of the moon. A shift also begins when the transmission is running in a prime circle ratio. Therefore, a tooth of each moon gear (180) aligns itself with its radius. A shift can begin at any point in the rotation of the moon gear (180) upon demand. A constraint is that it must end at that same point, whatever it might be. For the purposes of illustration, it is helpful to consider this system in terms of the chain or other driving/driven member wrapping completely around the circle formed and constrained by the sheaves. Because the arc distance that a moon gear (180) must travel before it engages the chain, has an exact duplication in length of the linear chain preparing to engage it. The arc distance is equal to the linear chain.

So, no matter what number of degrees the moon gears are from engaging the chain, the moon gear will begin correction so that it will engage synchronously when it actually meets the chain. And whether the circumference of the circle is increasing or decreasing, the correction begins immediately. Recall that the correction and radial increase or decrease is locked to the same shaft and is the distance away from the engagement that determines the amount of correction. If the disengaged moon gear and point where the chain contacts the sheave are 30 degrees apart, 30 degrees of correction will take place. This is the exact amount needed to synchronously engage the chain. If the disengaged moon and point where the chain contacts the sheave are 100 degrees apart, 100 degrees of correction will take place. This will continue for every moon gear in every position until the desired prime circle is reached. The number of prime circles achieved in a shift is determined by how long the gun stop is activated.

In the example case where three moon gears (180) are used (as few as two could be used, and more than three could be used), prime circles are separated by three links. One link being added per 120 degree sectors between moons. As the radius of the moon gears (180) increases, the arc distance between them increases and a prime circle is reached when one link is added to each 120 degree sector. Also, the correction of the moon gear (180) as it provides for the additional link, pertains only to its sector. This is true of all three moons. Therefore, they all rotate for correction in the same direction.

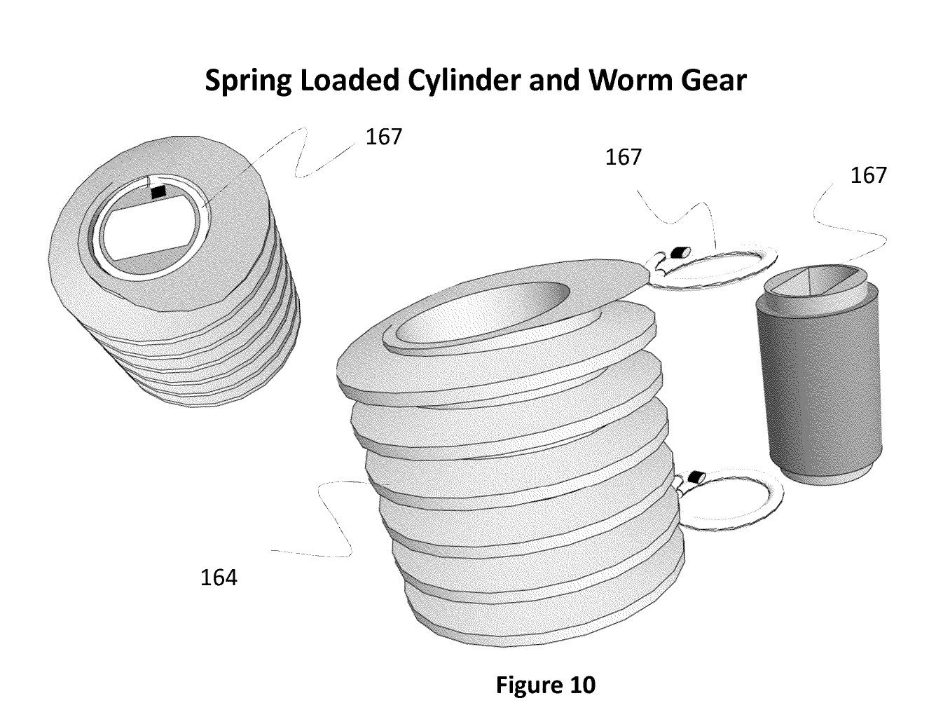

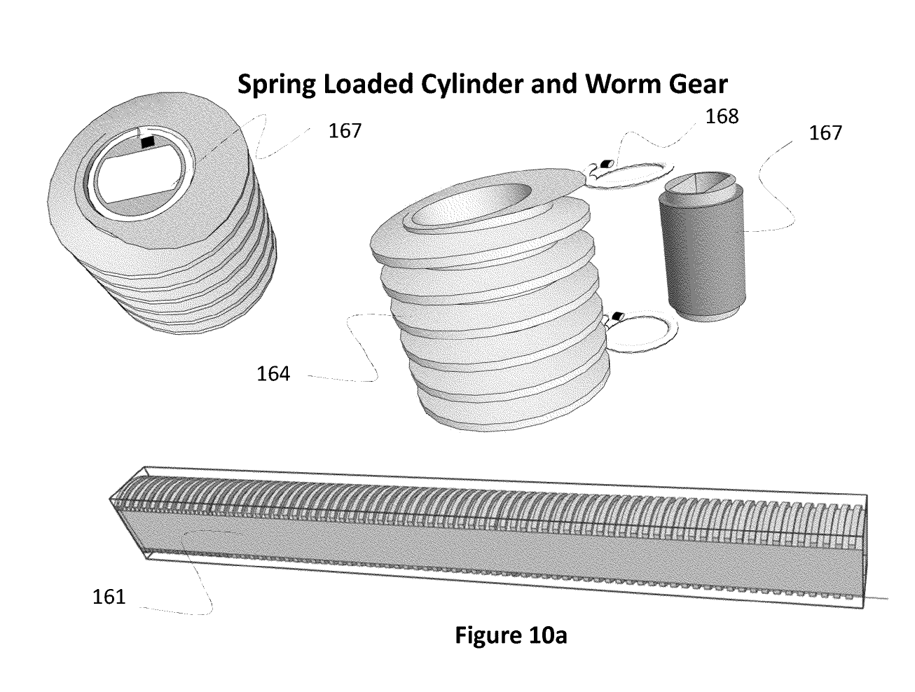

One exception to the rule arises during approximately 170° of a moon gears (180) engagement with the chain. Through this 170° angle a moon gear (180) is carrying the load of the chain and, as a result, cannot have its position corrected. This is the purpose of the worm gear (164) (FIG. 7). The spline/flat portion of the shaft (166) as seen in FIG. 7 fits into a spring loaded cylinder (167) that includes a pair of springs (168) (see FIG. 10). This allows for the small amount of correction needed to take place even though the worm gear (164) is unable to move due to the chain load acting upon the moon indexer gear (165) relationship. The spring loaded cylinder (167) allows the shaft (FIG. 10) to continue to move as though it were correcting the moon gear (180). When the load is released, the spring loaded cylinder (167) moves the worm gear (164) back into its position. Even when a though the moon is locked, it continues to change in radius.

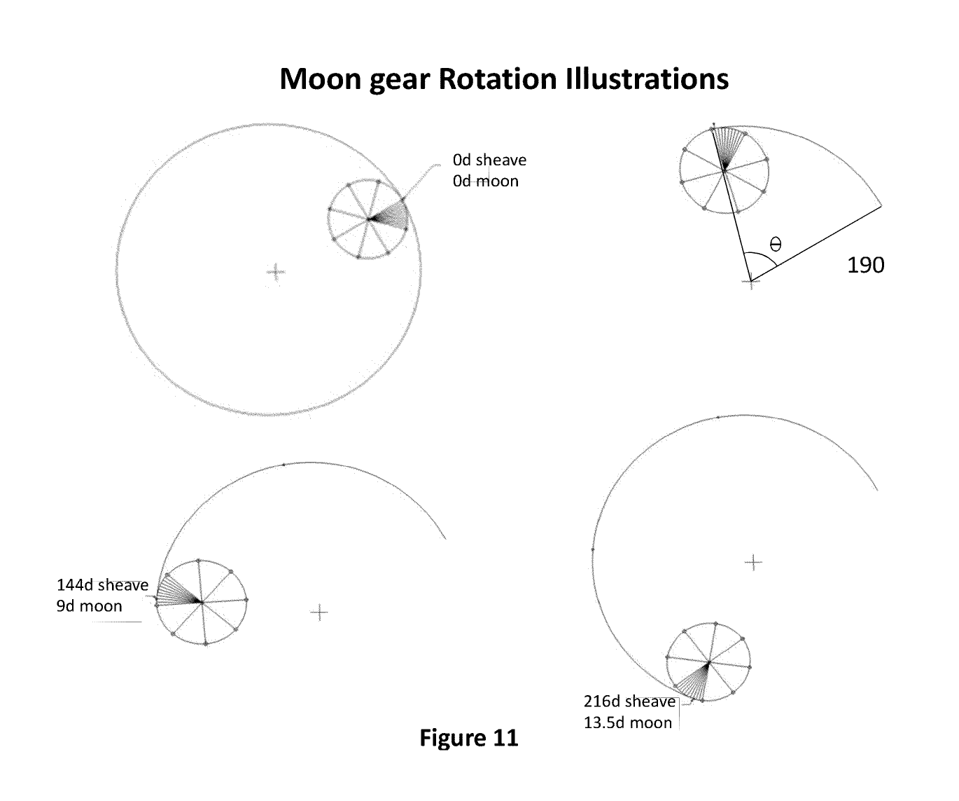

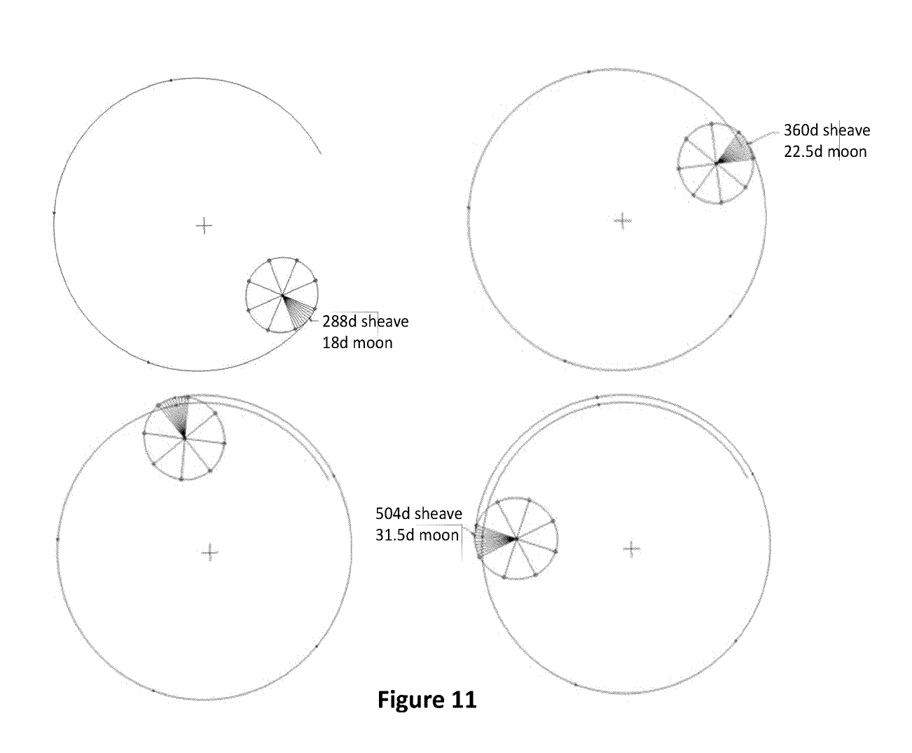

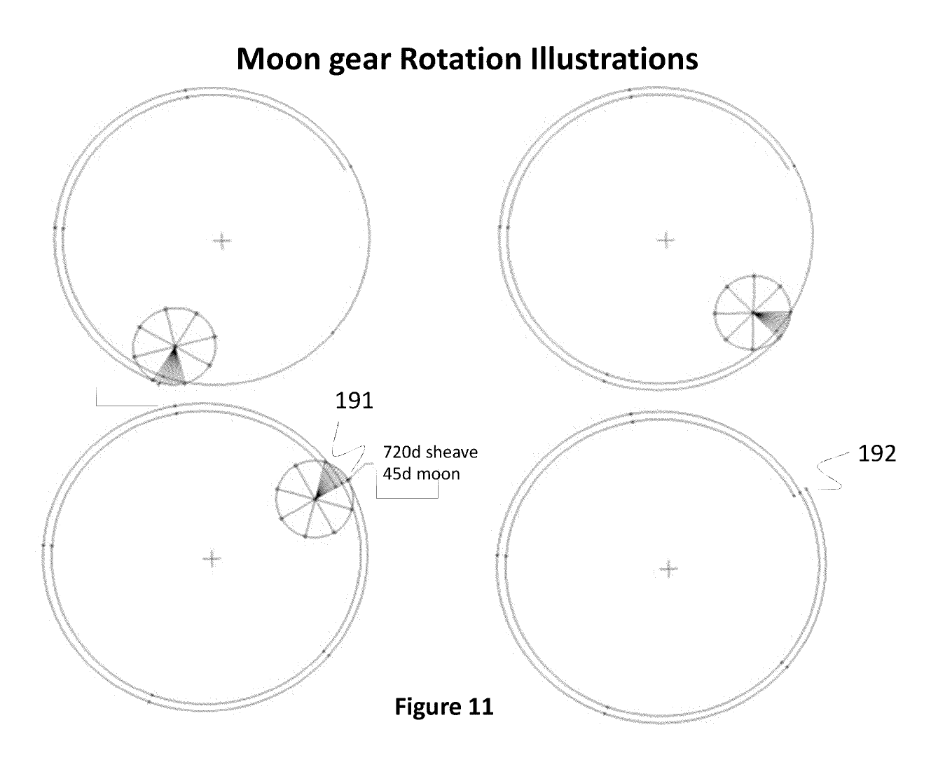

(FIG. 11), shows the angular orbital rotation (190) of the moon gear (180), while at the same time the moon gear (180) itself rotates rotation exhibit A (191). At rotation exhibit B (192) the path of the moon gear (180) is represented. These three linear features are pre-engineered to provide the desired shift as the application warrants.

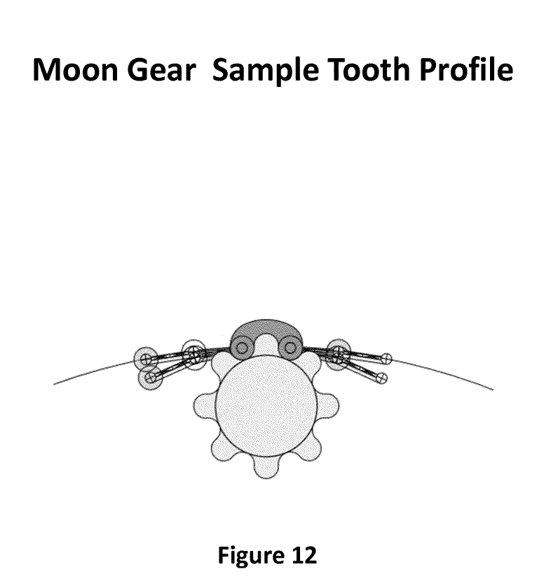

(FIG. 12), shows a sample moon gear (180) tooth profile that accommodates the engagement of the various arcs of the chain. This illustration is representative of a 30 to 80 link change in circumference.

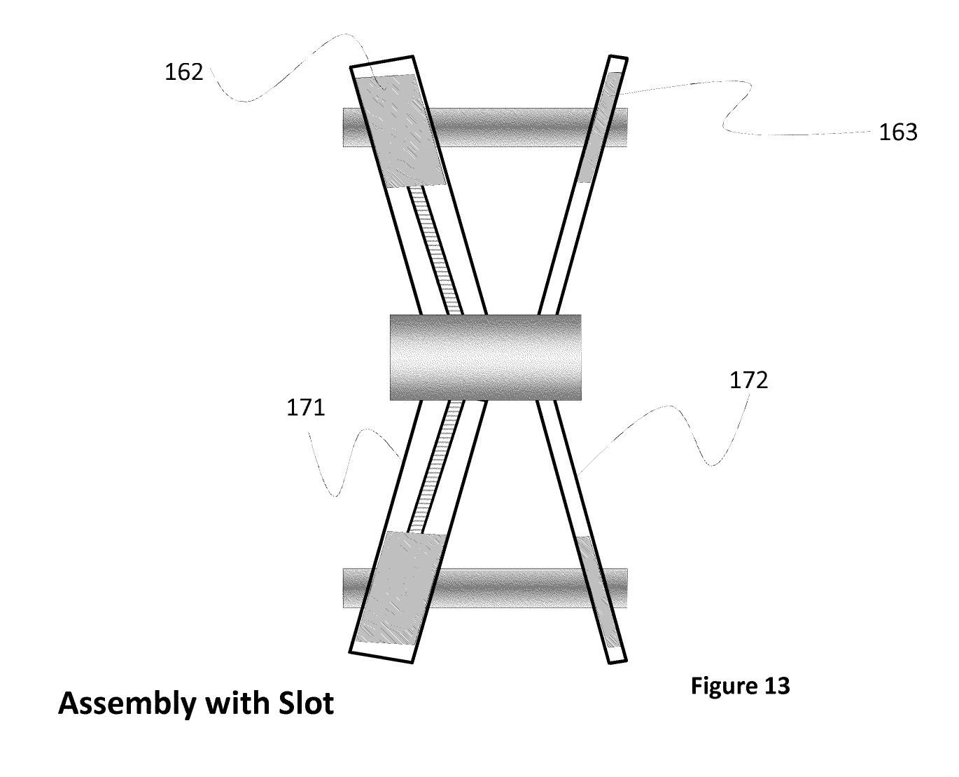

FIG. 13 discloses aspects of how sheave movement is facilitated and occurs in at least some embodiments of the invention. Traditionally, sheaves have been controlled in their together and apart movement by pushing and pulling against the sheaves respectively. This is mechanically very inefficient; an analogy would be like splitting a log with the flat side of an axe. As can be seen in (FIG. 13), not only is there the advantage of the threaded shaft, there is the large mechanical advantage of the wedging action of the primary sleds (162) and secondary sleds (163) pushing the primary sheave (171) and sheave (172) apart and together. To conclude with a final analogy, this approach is like splitting a log with the sharp end of the axe.

It will be appreciated that combinations of elements including one or more of the sleds 162/163, shaft 161, and worm gear 164 comprise example structural implementations of a means for synchronously, and automatically in at least some embodiments, performing any one or more of the following functions: implementing a change in moon gear radial distance from a reference axis (such as the shaft 400 for example); indexing of a moon gear to a full integer position; and effecting movement of one sheave relative to the other sheave. Any other element or combination of structural elements that are operable to perform such functions are likewise considered to be within the scope of the present disclosure.

Parts Name List

| # | Name |
|---|---|
| 9 | gun lock |
| 10 | gun lock housing |
| 11 | ball hole |
| 20 | housing pivot |
| 30 | ball link |
| 31 | ball |
| 32 | ball sphere |
| 40 | stop link |
| 41 | blue line |
| 42 | black line |
| 43 | green line |
| 44 | red line |
| 50 | stop |
| 51 | stop pivot |
| 60 | ball link spring |
| 70 | solenoid |
| 71 | solenoid plunger |
| 80 | ball ramp slide |
| 90 | T-slot guide |
| 110 | doubler side gear |
| 111 | four compression springs |
| 112 | doubler side gear striker |
| 113 | stop side gear striker |
| 120 | spider gear ring |
| 130 | spider gears |
| 140 | stop side gear |
| 151 | sun gear |
| 152 | ring gear |
| 160 | beveled gear |
| 161 | threaded spline shaft |
| 162 | primary sled |
| 163 | sled |
| 164 | worm gear |
| 165 | moon indexer gear |
| 166 | spline/flat portion of the shaft |
| 167 | spring loaded cylinder |
| 168 | spring |
| 170 | slot |
| 171 | primary sheave |
| 172 | sheave |
| 180 | moon gears |
| 190 | angular orbital rotation |
| 191 | rotation exhibit A |
| 192 | rotation exhibit B |
| 400 | main shaft |

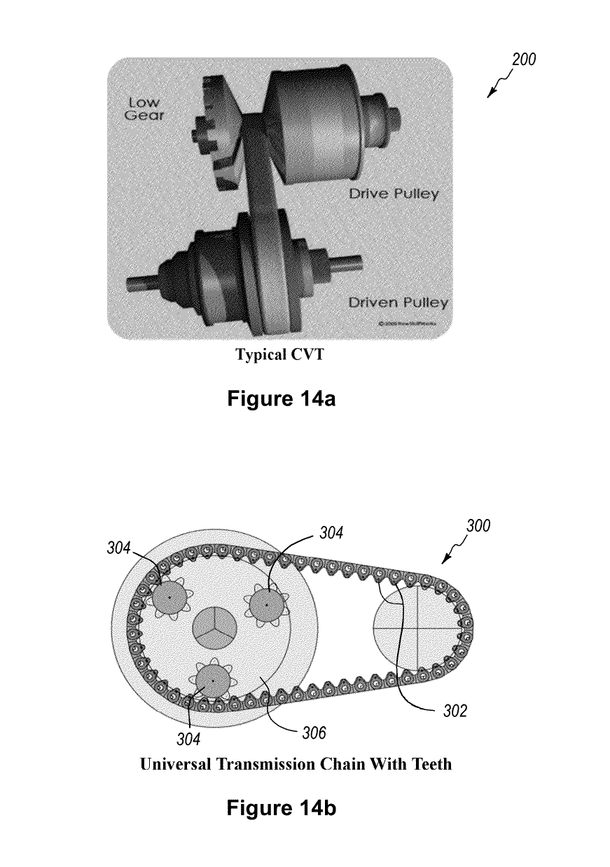

With attention now to FIGS. 14a-32, details are provided concerning further aspects of example embodiments of the invention.

Mechanical engineers continue to focus on transmissions known as Continuously Variable Transmissions (CVT). They embody a simple design with the ability to provide infinite ratios for great overall system efficiency. The CVT would likely be the transmission of choice for a majority of applications if it did not have the significant flaw of incorporating dynamic friction in the process that renders it unable to handle high torque. Though not in production, some CVT manufacturers have reported success with torques of up to 600 Nm but most handle far fewer Nms. To increase torque to minimally acceptable levels, CVTs are forced to utilize extraneous processes that add expense, parts, complications and decreased efficiencies.

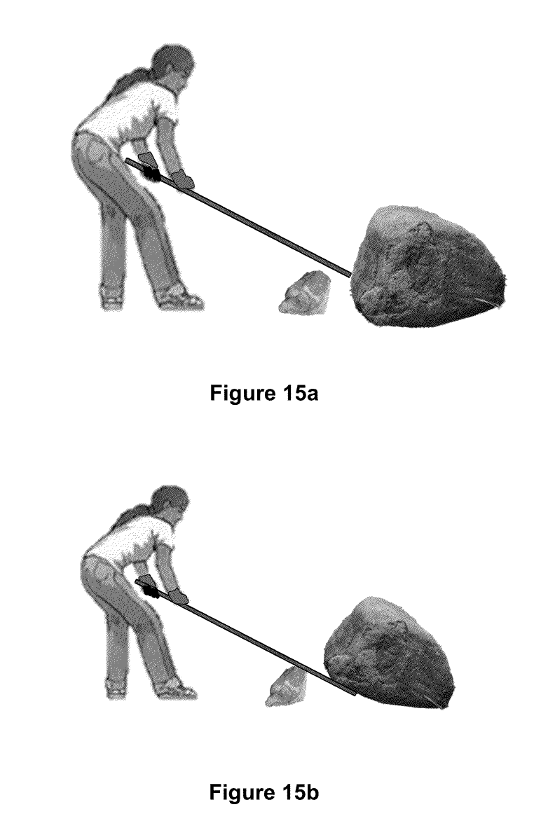

The embodiments of the transmission disclosed herein include a positively displaced mechanical CVT able to handle high torque. Some distinctions between a conventional CVT and the embodiments disclosed herein can be considered with reference to FIGS. 14a-15b.

In general, a CVT 200 such as that shown in FIG. 14a performs work through dynamic friction which is analogous to placing a lever against the side of a rock and using friction to lift the rock, as suggested in FIG. 15a. The advantage for the CVT 200 is that the fulcrum is able to vary, in very small increments, its ratio without interrupting the work. In contrast, the standard and automatic transmission must disengage and reengage in order to move to relatively few distinct ratios.

In contrast, and with reference to the illustration of FIG. 15b, the disclosed embodiments can perform high torque work because, by way of analogy, such embodiments place the lever under the rock like a standard transmission with gear sets does. Because of its unique moon gear-to-chain relationship and controller, and to continue the analogy, the fulcrum of the disclosed embodiments is able to be moved in infinite increments without interrupting the work to reset the fulcrum.

As indicated in FIG. 14b, embodiments of the invention can employ a belt 300 which is effectively a chain that has teeth 302 on its inner surface. These teeth are engaged by one or more moon gears 304 which are connected directly to a driving or driven member 306. As disclosed in more detail elsewhere herein, the moon gears 304 are designed for radial (and orbital) movement so that they may synchronously follow and engage the belt 300 in its inward and outward movement. In general, the moon gears 304 provide a positive displacement of torque from the input to the output of the mechanism.

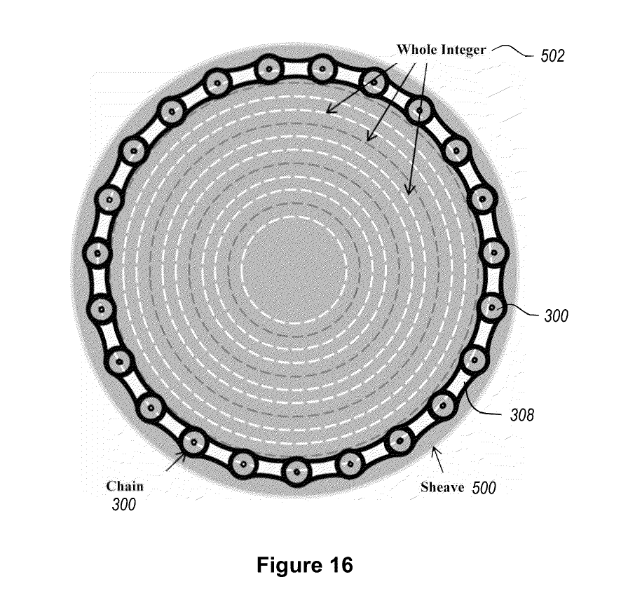

Both the CVT 200 transmission and the example embodiments disclosed herein use sheaves. However, the sheave face on the CVT 200 is used to transfer the torque, thus requiring powerful hydraulics to clamp the belt with the sheaves. In the embodiments of the invention disclosed herein, the sheaves are used primarily to form circles. Consequently, the sheave-clamping force employed by embodiments of the invention to maintain a circle with the belt or chain can be, in some cases at least, as little as ⅓ of that needed in a typical friction CVT like the CVT 200. With reference now to the example chain 300 and sheave 500 configuration and arrangement disclosed in FIG. 16, details are provided concerning the concept and use of infinite circles and integer circles. In general, and as suggested in FIG. 16, an infinite number of circles can be demarcated on the surface of the sheave 500. When introducing a chain and moon gear 304 with finite part dimensions into the equation which contains an infinite number of circles, it is necessary to differentiate between the circles. Once the size of a link 308 of the chain 300 is determined, the difference between whole tooth (integer) circles and partial integer circles can be calculated.

In more detail, an integer is a number that can be written without a fractional component. In the context of the chain 300 and sheave 500 relationship, whole integer circles are defined as: a circle of chain formed between two sheaves which contain a whole number of links in it. Every time a link is added or subtracted to the chain, a new whole link/integer circle is thus defined. Using this process, all the whole integer circles for any given sheave diameter can be defined.

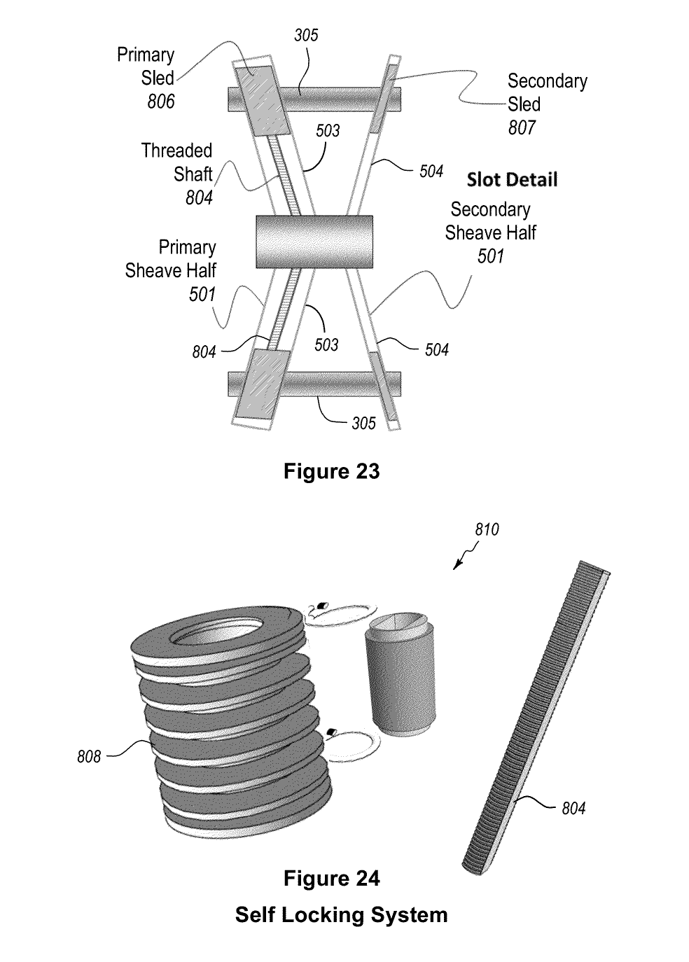

It will be appreciated that the position of the whole integer is predictable and determined by the length of the chain link 308 and the cosine of the slope (see FIG. 23 for example) of the sheave 500 face. In particular:

(2r=t/π)/cos, where:

r=the radial distance between whole integer circles

t=the length of a tooth

cos=cosine of the sheave angle

Bearing this relationship in mind, the configuration shown in FIG. 16 is representative of the different whole integer virtual circles. That configuration also shows the space between the circles which would contain an infinite number of what are referred to herein as partial integer circles.

With continuing reference to FIG. 16, a distinction can be drawn between two different types of whole integer circles 502, namely, a prime whole integer circle and a non-prime whole integer circle. The distinction between prime and non-prime whole integer circles, or simply prime and non-prime circles, is determined by the number of driving members employed. For the purposes of this illustrative example, three driving members or moon gears 304 are assumed but, of course, more or fewer moon gears could be employed.

Adding or deleting one link to a whole integer circle creates another whole integer circle. However, in this illustrative example, one link added to a circle of chain does not result in a number of links that can be divided wholly by the number of moon gears, that is, three moon gears 304. Rather, the quotient in this example would be a partial integer. For example, an arc distance between successive moon gears 304 of eight and ⅓ links cannot be defined without some adjustment to the moon gear 304 alignment. In an effort to define the difference between integer circles 502 that require adjustment of the alignment of the moon gear 304 and the differences that do not, a distinction must be drawn between integer circles 502 in which the chain 300 and moon gear 304 can rotate without adjustment and the moon gear alignment(s) that need adjusting. When the number of links 308 in a whole integer circle 502 is divisible by the number of moon gears 304, that whole integer circle 502 constitutes a prime whole integer circle. At such a circumference, the alignment of the moon gear 304 would not require an adjustment. In this example scenario, every third whole integer circle 502 would constitute a prime whole integer circle and every other whole integer circle 502 would constitute a non-prime whole integer circle.

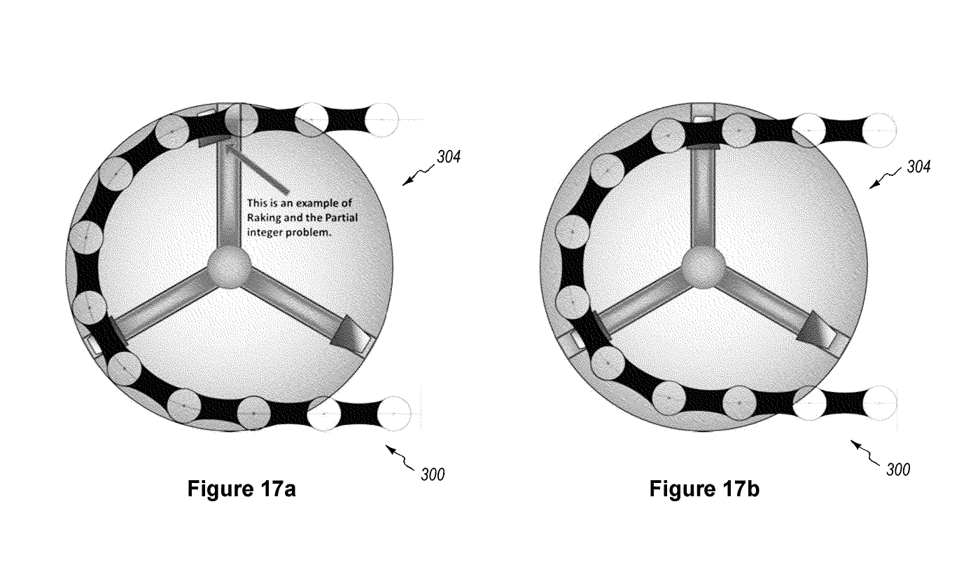

With reference now to FIGS. 17a and 17b, further details are provided concerning the raking phenomenon mentioned earlier, and to some related considerations. With respect to these Figures, it should be noted that they are intended to convey concepts that can apply to a variety of embodiments. Accordingly, no particular sizes, angles, amounts, numbers, etc. are set forth here. As well, the use of various parts would be apparent to one of ordinary skill in the art and consequently a detailed disclosure of such parts, which can include the following, is omitted: bearings, bolts, thrust washers, keepers, splines, retainers, etc. Similarly, gear types such as spur, helical, etc. could be determined by one of ordinary skill in the art having the benefit of this disclosure and knowledge available in the art. For the purposes of this discussion and illustration, a three moon gear model is assumed.

Initially, it is useful to consider some differences between a gear shift, or shift, and an indexing process. Particularly, when a moon gear 304 and chain 300 move from one whole integer to another it is called a shift. Indexing describes the rotational adjustment the moon gears 304 must make, as they move through partial integer circles. Because indexing is such an integral part of the shift, the two terms, indexing and shift, are often used interchangeably in this document. However, technically a shift refers to both the radial change in orbit of a moon gear 304 combined with the radial rotation of the moon gear 304, and indexing refers to only the radial rotation of the moon gear 304. In order to implement a shift, the moon gear 304 simultaneously changes its radial orbit, that is, its radial position relative to a fixed point such as an axis defined by a common shaft about which the moon gears 304 all rotate, and the moon gear also changes its radial rotation.

When two or more driving members, such as moon gears 304 for example, are engaged with the chain 300 at the same time and the system is moving to a different whole integer circle, the moon gear 304 will rake in relation to the chain 304. That is, a tooth of the moon gear 304 will engage the chain 300 at a location other than the middle of a link of the chain 300. Not only is the engagement location problematic, but the orientation of the tooth will also be incorrect. As shown in FIG. 17a for example, the tooth is tilted relative to the center of the link, rather than being in a vertical orientation as shown in FIG. 17b, and the tooth also engages one edge, but not the other, of the interior of the link.

If raking is not resolved, the moon gear 304 and/or the chain 300 will break. In more detail, raking occurs when the transmission has three or more moon gears 304, as illustrated in the example of FIGS. 17a and 17b. Raking results because the distance between the links 308 is constant and as the moon gears 304 collectively defined radius increases or decreases, so does the arc distance between successive moon gears 304. By selective indexing of one or more moon gears 304, the raking problem can be prevented.

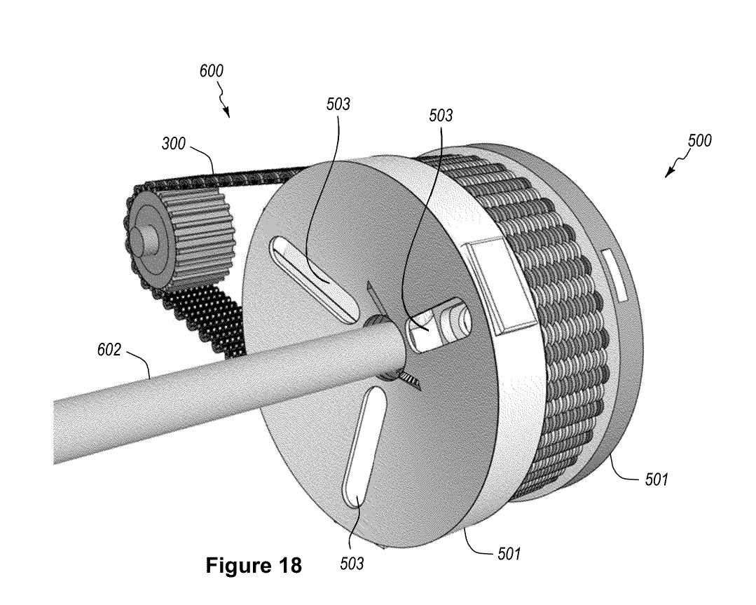

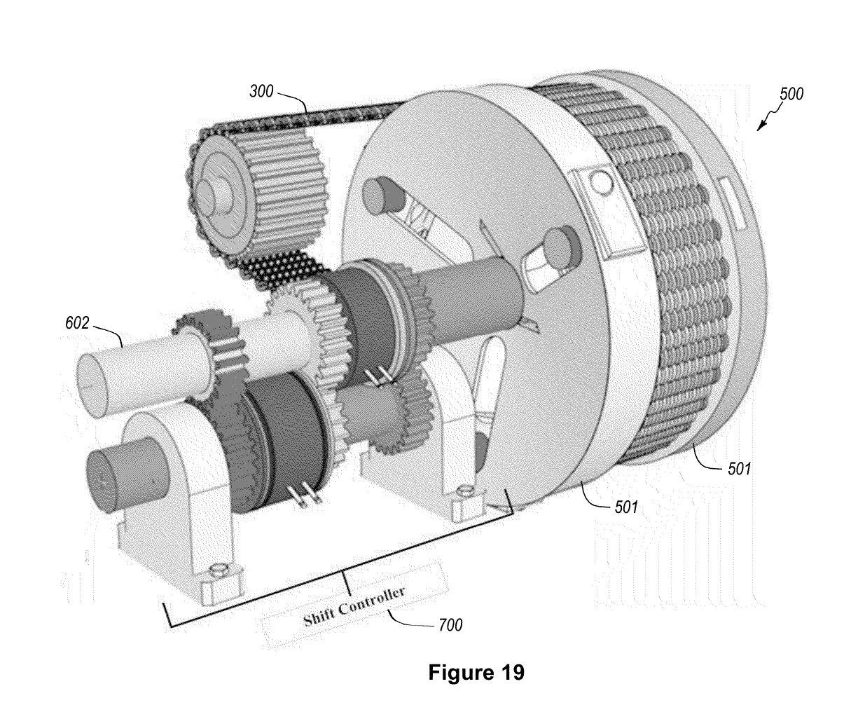

Turning now to FIGS. 18 and 19, details are provided concerning an example embodiment of a transmission, denoted generally at 600. As indicated, the transmission 600 includes a sheave 500 that includes sheave halves 501 mounted to an input shaft 602, and one or both of the sheave halves are configured for axial movement along the input shaft 602. The sheave halves 501 may each include multiple radially oriented slots 503 that are equally spaced apart. In the example of FIGS. 18 and 19, three such slots are indicated and are spaced about 120 degrees apart from each other, although more or fewer slots could be employed. The chain 300 engages the sheave halves 501 in such a way as to be received between the sheave halves 501.

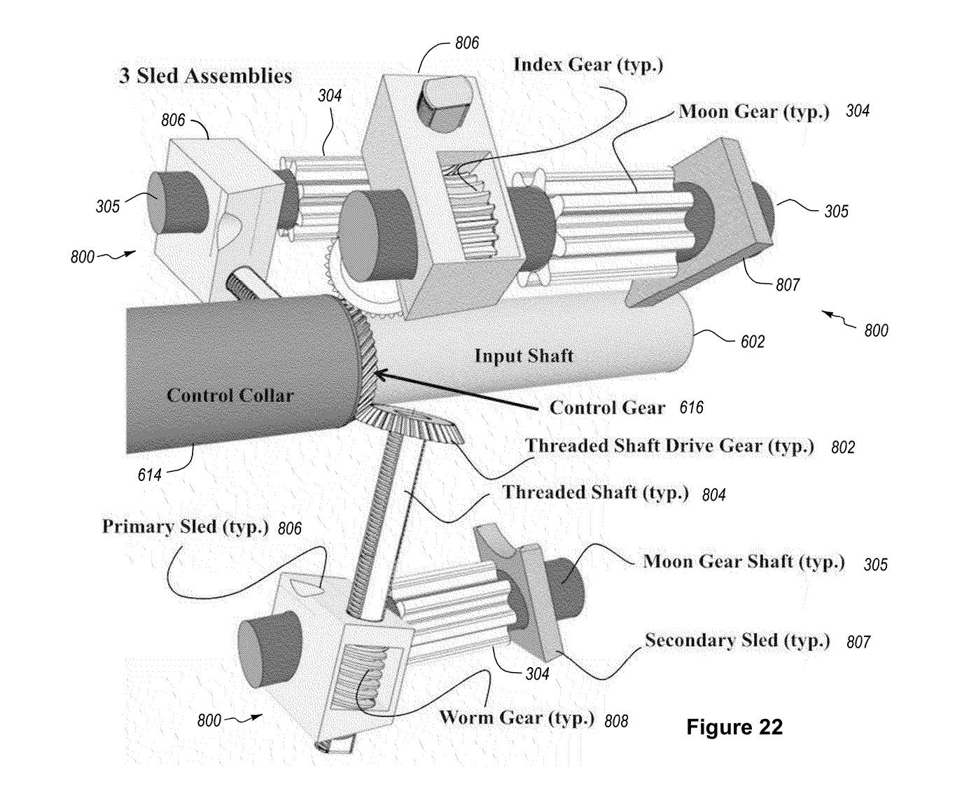

As indicated in FIG. 19 and discussed in more detail below, a shift controller 700 is also provided that interfaces with the transmission 600. In general, it will be appreciated that when a shift begins, many parts begin to move simultaneously. To keep the discussion clear, the description of a shift will move from the first component activated and then follow a torque flow path until the last component in the process is reached. The shift controller 700 gets its power to make changes in ratio by means of the input rotation being modified to create a relative rotational motion that powers the shift mechanism. A mechanical force is generated when two components are rotating at different speeds. This difference in speed creates a potential force which is then captured by the threaded shaft (see FIG. 22) to shift the mechanism up or down. The closer the relative difference in rotation is, the slower the shift mechanism operates and, thus, the slower the shift occurs. Conversely, the wider the separation is in relative motion, the faster a shift will occur. Because of this unique method of moving the sheaves, much smaller forces are required. This has a positive effect on the size of all parts throughout the drivetrain of the entire vehicle.

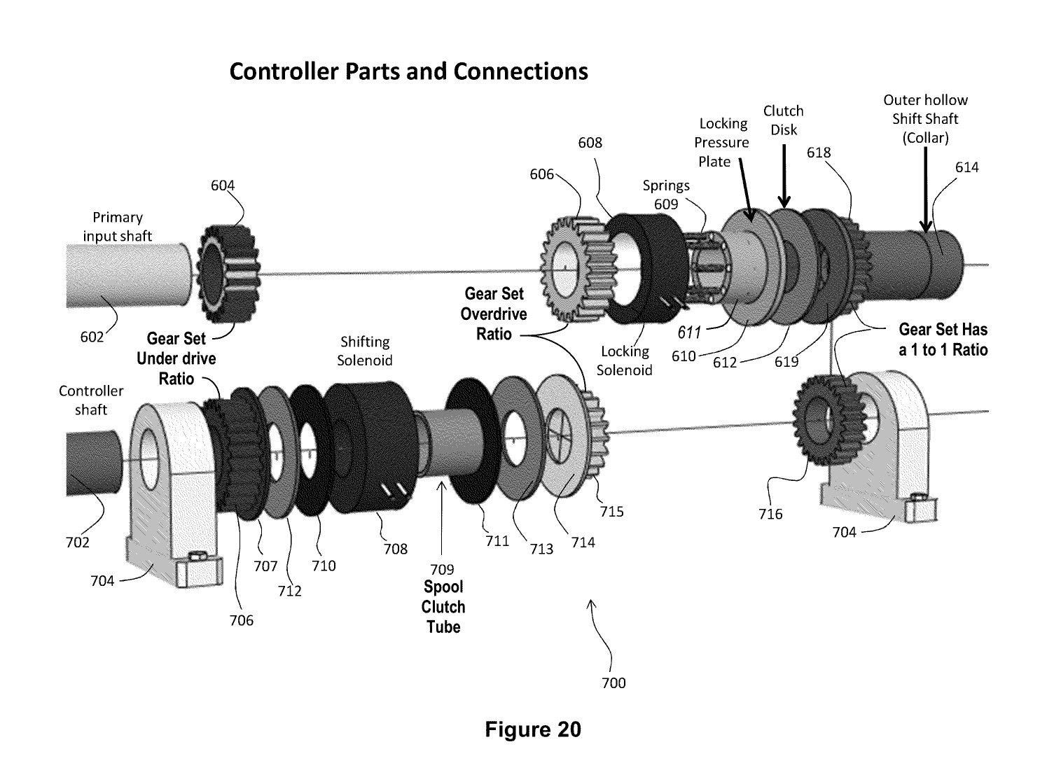

With reference now to FIG. 20, further details are provided concerning the structure and operation of the shift controller 700. The shift controller 700, in the illustrated embodiment, includes a controller shaft 702 that is rotatably supported by bearings 704. A control shaft drive gear 706 with an affixed pressure plate 707 are disposed on the controller shaft 702 and configured to engage a corresponding matched smaller drive gear 604 disposed on the input shaft 602, which engagement creates an under-drive relationship between the input shaft 602 and the controller shaft 702. Next, a shifting solenoid 708 is provided that is mounted and secured to the transmission housing (not shown). The correct alignment of the shifting solenoid 708 within the solenoid pressure plate 710 is shown in FIGS. 19 and 20. The shifting solenoid 708 can be electrically powered, and controlled by an automatic control system. During construction of the shift control 700, the center portion of the spool clutch 709, which includes pressure plates 710 and 711, is slid into the shifting solenoid 708. The side pressure plates 710 and 711 are then secured to the tube of the spool clutch 709 and, together, these elements collectively form the spool clutch 709. The thimble clutch is movable along, the controller shaft 702. In at least some embodiments, the spool clutch 709 is mounted to the controller shaft 702 using a splined arrangement whereby the spool clutch 709 can rotate in unison with the controller shaft 702 while also moving axially along the controller shaft 702.

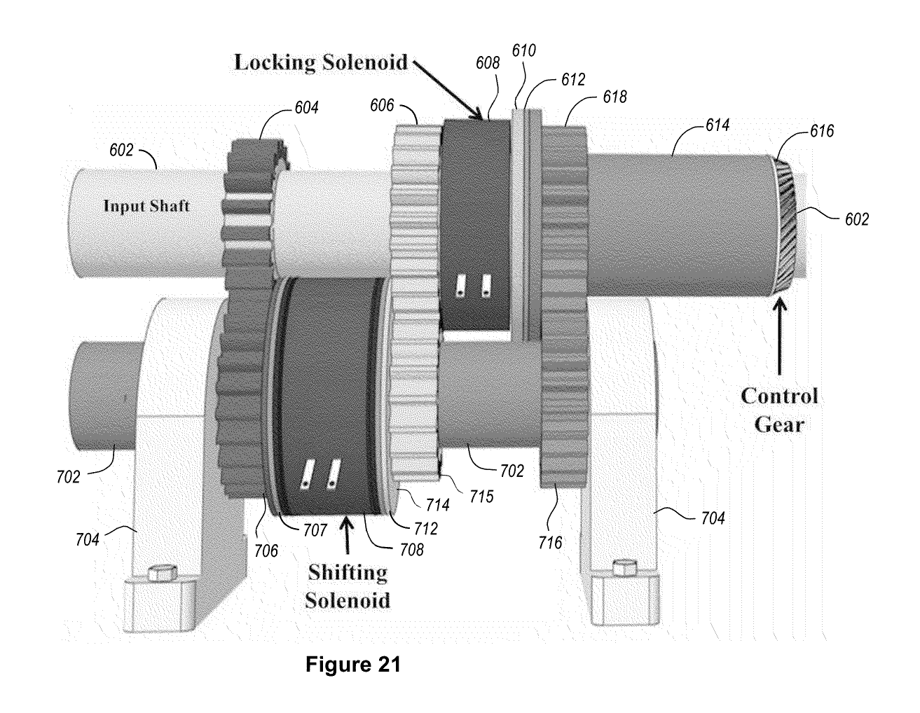

With continued reference to FIG. 20, clutch disk 712 and 713 are disposed on the controller shaft 702 on both sides of the spool clutch 709. As indicated in FIGS. 20 and 21, the spool clutch 709 including pressure plates 710 and 711 are components of, and house, the shifting solenoid 708. With respect to the foregoing discussion it should be noted the shifting pressure plates 707 and 714, in this embodiment at least, do not have springs except the locking pressure plate 610. As well, all of the pressure plates 707, 714, & 619 are secured, by welding or some other suitable method, to their respective gears 706, 715 and 618. The pressure plate 610 is not affixed to any gear. However, pressure plate 610 is secured to a metal tube 611 which extends into the locking solenoid 608 for the purpose of providing force against the springs 609 which release the locking clutch disk 612 during a shift.

The purposes for an under-drive or over-drive shift are in principle the same. In order to understand how a shift takes place it should first be understood that the input shaft 602 and the controller shaft 702 are parallel. Moreover, gear 604 and gear 606, which is larger than gear 604, are secured to the input shaft 602. Whereas gear pairs 604/706 and 606/715 form respective gear sets, then gear set 604/706 is an under-drive gear set and gear set 606/715 is an over-drive gear set.

In operation, a downshift is controlled by the under-drive gear set 604/706, the downshift would begin by passing electrical current through the shifting solenoid 708 such that the spool clutch 709 (along with pressure plate 710) would be forcefully pressed against the clutch disk 712. By means of friction, the rotational torque coming from the input shaft 602 would pass through the drive gear 604 and be transmitted to control shaft drive gear 706. That is, control shaft drive gear 706 is free to rotate about the control shaft 702 until the friction between pressure plate 707, attached to gear 706, and the clutch disk 712 reaches the point where the pressure plate 707 and gear 706 are compelled to rotate in unison with the under drive gear 604. This frictional force between the pressure plate 707 and clutch disk 712 is provided by the pressure of the spool clutch 709 on the clutch disk 712. As a result of the aforementioned configuration and arrangement, the input shaft 602 rotates at the under-drive speed. More particularly, this is accomplished by the aforementioned splines on the inner tubular portion of the spool clutch 709. The controller shaft 702 is affixed to the spool clutch 709 and the control shaft drive gear 716. The control shaft drive gear 716 is engaged with the collar shaft driven gear 618 which is securely attached to, and drives, control collar 614 and the connected control gear 616. In summary, everything from the spool clutch 709 to the control gear 616 are always connected.

With continued reference to FIGS. 20 and 21, details are provided concerning example embodiments of a locking solenoid and associated components that operate in connection with the shift controller 700. In addition to the components already noted, various other components are mounted to the input shaft 602. For example, and as discussed in more detail below, a locking solenoid 608 is provided that can be similar in structure and operation to the shifting solenoid 708. As well, a clutch pressure plate 610 and clutch disk 612 assembly are provided that are mounted to the input shaft 602. A control collar 614 is also provided that includes a hollow interior which receives a portion of the input shaft 602. A control gear 616, which can be a bevel gear for example, is located at or near the end of the control collar 614. When the transmission is running, i.e., not shifting, both the locking solenoid 608 and shifting solenoid 708 are deactivated. The locking pressure plate springs 609 forces the pressure plate against the clutch disk 612, creating friction between the pressure plates 610 and 619 sufficient to force them to rotate at the same velocity. In this condition there is no relative motion between the input shaft 602 and the control gear 616.

With the arrangements of FIGS. 20 and 21 in view, details are provided now concerning some operation aspects of the illustrated embodiment. In general, the purpose of the shift controller 700 is to create a difference in rotational speeds between the input shaft 602 and the threaded shaft drive gear (see FIG. 22) that is engaged, or engageable, with the control gear 616.

In more detail, when the shifting solenoid 708 is activated for a downshift, it pushes and pulls the pressure plate 707 to the left (in FIGS. 20 and 21). This operation serves to transfer input torque from the input shaft 602, through the 604/706 gear set to pressure plate 707. The solenoid pressure plate 710 forces the clutch disk 712 to contact the pressure plate 707. The clutch disk 712 modifies the solenoid pressure plate 710 and assembly 614/618 rotation to an under-drive speed. Both the gears 618 and 716 will be the same size in at least some embodiments. This configuration allows, during a shift, for the overdrive gear set 606/715 and the under-drive gear set 604/706 to determine the relative rotation speeds between the shift controller 700 and input shaft 602.

Simultaneously the locking solenoid 608 releases the assembly 614/618 from rotating at input speed. In this way, torque is transferred to the control gear 616. The input shaft 602 is allowed to rotate inside of the control collar 614 thus allowing relative motion between those two components during a shift. An upshift is the same except the solenoid pressure plate 710 moves right and causes the engagement of gears 715 and 606.

Directing attention now to FIGS. 22 and 23, details are provided concerning structural and operational aspects of an example sled assembly, particularly as the sled assembly relates to the shift controller 700. In general, the relative motion provided by the shift controller 700 operates the sled assemblies 800 to radially move, and index, the moon gears 304. Each sled assembly 800 is housed inside a respective slot 503 (see, e.g., FIGS. 18 and 19). As discussed below, the sled assemblies 800 each are configured and arranged to synchronously perform at least nine distinct functions.

For example, during running operations, the control collar 614, collar shaft driven gear 618, and threaded shaft drive gear 802 rotate at the same rotational speed as the input shaft 602, sheave halves 501, and sled assemblies 800. The moon gears 304 are (i) in an orbit equal to the radius of a whole integer, and (ii) in a fixed radial position for an accurate engagement with the chain. With this configuration and arrangement, the shift controller 700 and sled assemblies 800 can cooperate to perform the functions indicated below. In particular, the shift controller 700 and sled assemblies 800 can simultaneously and synchronously change the ratio of the transmission 600 by accomplishing the following linear, and mechanically linked, functions:

1. Rotate the threaded shafts 804 to which the threaded shaft drive gears 802 are mounted. The threaded shafts 804 may optionally rotate in one direction for an upshift, and may optionally rotate in the opposite direction for a downshift. The threaded shafts 804 engage respective sleds 806 by way of threads tapped into the body of each of the sleds 806.

2. The rotation of the threaded shafts 804 change the radial position of the sled assemblies 800, relative to the input shaft 602, which enables the moon gears 304 and the chain 300 to slide the moon gears 304 between smaller and larger radii and consequently define different gear ratios.

3. The sleds 806 also operate to change the distance between the sheave halves 501. As well, the moon gear shafts 305, which constrain respective sleds 806, insure that the respective distances between the sleds 806, and the sleds 807, is constant. The sleds 806 may be referred to as primary sleds, while the sleds 807 may be referred to as secondary sleds.

4. As a consequence of the foregoing, the chain 300 is moved radially. The changing radius provides the desired ratio to the sprocket or a second set of sheaves to the output shaft.

5. The moon gears 304, which are affixed to their shafts 305 that extend through primary and secondary sleds 806 and 807, maintain constant engagement with the chain 300.

6. The threaded shafts 804, by way of worm gears 808, rotate so as to index the moon gears 304.

7. The threaded shafts 804, by of the shift controller 700, stop the shift when the moon gears 304 reach a prime whole integer circumferences. This condition may be referred to herein as the running condition.

8. The leading worm gear 808 locks the chain 300.

9. Pre-determined shift characteristics effect the shift, as discussed in more detail below.

Directing attention now to FIG. 23, further details are provided concerning the sheave dynamics introduce in 3. above. Traditionally, sheaves have been controlled in their linear movement by pushing and pulling against the sheaves, respectively. This is mechanically very inefficient and can be thought of as being analogous to splitting a log with the flat side of an axe. The primary and secondary sleds 806 and 807 are constrained by the moon gear shafts 305 to maintain a fixed distance apart. As disclosed in FIG. 23, not only is there the mechanical advantage of the threaded shaft 804, there is the large mechanical advantage of the wedging action of the primary sled 806 and secondary sled 807 pushing the primary sheave and secondary sheave apart and together as they move one direction, or the other, in the slots 503 (primary sleds 806) and 504 (secondary sleds 807). This can be thought of as analogous to splitting a log with the sharp edge of the axe. In this particular example, the vector force required to move the sheave halves 501 by this method is comparable to a vector force being equal to the sine of about 15 degrees.

With continued reference to the Figures, including FIGS. 22 and 23, further details are provided concerning the indexing process introduced at 6. above. It should be noted that, initially, all the moon gears 304, having a common connection, start at the same time and in identical positions. The moon gears 304 simultaneously and equally change orbit as they index by rotation about their respective axes. All three moon gears 304 correct for the amount that the chain length effectively increases or decreases during a shift. In the illustrative example presently under consideration, three links of chain per prime integer were added. Thus, each moon gear 304 must accordingly correct three teeth.

This can be accomplished because the transmission 600 does not require two moon gears 304 that are engaged with the chain 300 to index, that is, rotate about their axes, at the same time. Even though there are, for 120°, two moon gears 304 engaged with the chain 300, the load bearing moon gear 304 is locked in place and the spring loaded cylinder (see discussion of FIG. 24 below) is allowing the moon gear 304 to index. When the load bearing moon gear 304 is disengaged from the chain 300, the load bearing moon gear 304 it will have approximately 180° of orbit distance available for the spring cylinder to restore the load bearing moon gear 304, which is no longer bearing a load due to its disengagement from the chain 300, to its synchronous position with the chain 300. When one of the moon gears 304 is locked in place and carrying the load, the other engaged moon gear(s) indexes exactly what is needed for the amount of chain 300 that is being added (or subtracted).

Each of the 120° angular separation between moon gear is referred to as a sector. Each sector has to add one link to reach the next prime whole integer. But each moon gear 304 corrects at the same rate that the chain is being added and, as such, the moon gears 304 are always engaged in a non-raking relation with the chain 300, notwithstanding that shifts which affect the effective length of the chain 300 may be occurring.

As explained in the following discussion, angular position of the moon gears 304 is a dynamic part of the formula concerning operation of the transmission 600 and implementation of shifts between gear ratios.

When a moon gear 304 designated arbitrarily as #1 304 engages the chain 300, the next moon gear 304 to engage, moon gear #2, is spaced 120° away from moon gear 304 #1. This additional 120° of orbital rotation distance enables the moon gear 304 to implement its proportionate amount of indexing that allows the moon gear 304 to engage precisely with the chain 300. When all three moon gears 304 are in respective whole integer positions, their teeth are lined up for synchronous engagement with the chain 300, and they are also all in the same identical position, such as top dead center.

When a shift begins, all of the moon gears 304 begin to correct the same amount equal to the proportionate amount of their circumference increase (or decrease). The end goal is that when it reaches the next prime whole integer circle, the moon gear 304 will have indexed the number of teeth equal to the number of links added to the chain 300. But along the way, each moon gear 304 walks, or indexes, an equal amount. The difference between the moon gears 304 is their arc length, or number of degrees, away from their engagement with the chain 304. So, a moon gear 304 that is 240° away has twice as much angle to correct as a moon gear 304 that is 120° away. While there is a certain amount of time available to index the moon gear 304, this window of opportunity for indexing can be thought of in terms of the angular difference between the moon gear 304 and its engagement with the chain 300. This notion may be referred to herein as a moon walk. The distance of the walk of the moon gear 304 coincides with the amount of chain 300, added or subtracted, due to the increase or decrease in its circumference around the sheave 500.

The moon gear 304 will index one tooth for every link of chain added to any given circumference. The additional amount of orbit each moon gear 304 travels in addition to its previous moon gear 304 is directly proportional to the amount of additional chain 300 needed for a larger (or smaller) circumference. All of these relationships are linear and therefore can be and are mechanically linked together.

A shift can begin at any point in the rotation of the sheave 500 upon demand, but the orbital position of the moon gear 304 must end at a prime whole integer circle or when the moon gear 304 teeth reach TDC. The number of prime circles achieved in a shift is determined by how long the solenoid is activated. In general, a shift requires an increase or decrease in the radius collectively defined by the moon gears 304. This requires the moon gear 304 to pass through possibly several rotations in which the teeth of the moon gears 304 could collide with the chain 300 until the moon gear(s) 304 reached the next whole integer, referred to as a prime circle, as noted herein. The synchronizing characteristics that have been explained provide a correction of the moon gear 304 such that a synchronous engagement between moon gears 304 and chain 300 always takes place.

With reference now to FIGS. 22 and 24 in particular, further details are provided concerning the indexing process introduced at 8. above. At least one of the moon gears 304 must lock into place in order to carry the load to or from the chain 300. To this end, a spring loaded cylinder 810 is provided fits inside of each of the three worm gears 808 (see FIG. 22). The flat portion of the threaded shaft 804 fits into the flat portion of the spring loaded cylinder 810. The spring loaded cylinder 810 allows the threaded shaft 804 to index while the worm gear 808 is under load and unable to rotate.

The relationship between the index gear 812 and the worm gear 808 provides a mechanism whereby a self-locking system can be utilized. First the load of the chain 300 rotates the moon gear 304 which is connected directly to the index gear 812. Because of the large mechanical disadvantage of the index gear 812 with the worm gear 808, the index gear 812 is unable to rotate the worm gear 808. When one of the moon gears 304 is carrying the load of the chain 300, the index gear 812 pushes the worm gear 808 onto its end. Between the locking characteristics of the worm gear 808 and the friction of the worm gear 808 against its end, the moon gear 304 is prevented from rotating. The spring loaded cylinder 810 allows the threaded shaft 804 to continue to index as though it were correcting the moon gear 304. When the chain 300 load is removed, during the approximate 180 degrees in which the moon gear is disengaged from the chain 300, the spring loaded cylinder 810 moves the worm gear back into its appropriate indexed position. Thus, even though the moon gear 304 is locked for whatever reason, its spring loaded cylinder 810 allows the moon gear 304 to index.

In this example scenario, each leading moon gear 304 would be required to carry the chain 300 load for approximately 120 degrees. To insure that the worm gear 808 remains in place, the tolerances between the worm gear 808 and its associated sled 806 housing would be close. The material on the ends of the worm gear 808 and its associated sled housing 806 would also be of a high coefficient of friction such as a small clutch disk. Because the worm gear 808 would not turn while under load, it is not anticipated that this portion of the mechanism would be subject to adverse wear. It can be appreciated that this worm gear design lends itself to a method of lining up the moon gear with the chain. A small detent which is housed in the sled in a position that precedes engagement can act as a mechanism to perfectly line up the moon gear 304 teeth with the chain 300 similar to methods used to prevent and overcome backlash.

Directing continued attention to the Figures, further details are provided concerning the sheave dynamics introduce in 9. above. By means of the shift controller 700, a choice can be made as to how many input revolutions it takes to move between prime whole integers. Because it does not matter how fast or slow the moon gears 304 get to the next prime whole integer orbit, this arrangement provides great flexibility in pre-engineering the transmission 600 for any application.

In general, the components and their movements are all interrelated and form a ratio relationship that can be pre-engineered and manipulated depending upon the application. For example, the number of degrees that a sheave 500 rotates to complete a shift can vary with respect to the orbital radius increase (or decrease) and indexing of the moon gears 304. A shift from one prime whole integer to the next can take place in 5 revolutions, or 60 revolutions, of the sheave 500. This synchronized shift design can start a shift from any prime whole integer, in any angular position of the sheave 500 and for any number of rotations of the input.

One unique feature of this design is that one divides every three links of a 120° sector (which represents prime whole integers) into as many degrees of input rotation as the application warrants. Put another way, the moon gears 304 can transcend X number of prime integers in Y number of sheave 500 revolutions. Because the transmission 600 is constantly engaged and the engine never disconnected from the load, this option can be applied to manipulate the torque loads on the entire drive train.

A paradigm in vehicle design is to shift fast and to create more ratios. The present design and embodiments represent a paradigm shift to where time between shifts is a variable used at the discretion of the design engineer. It is not restricted by the traditional quick shift mentality. This is, at least in part, due to the shift being infinitely variable by nature.

While shifting from one operating ratio to the next desired operating ratio, the designer can use as many engine output revolutions as desired, and can make the shift transition in small or large increments of engine RPMs. There are many variables that can be utilized in the design that modify the outcome to meet design objectives, such as: The shift controller 700 over and under drive gear ratios, the ratio between the control gear 616 and the threaded shaft drive gears 802, the number of threads/mm on the threaded shaft 804 and the ratio between the worm gear 808 and the index gear 812, to name several examples. Yet other examples of variables will be apparent from the present disclosure.

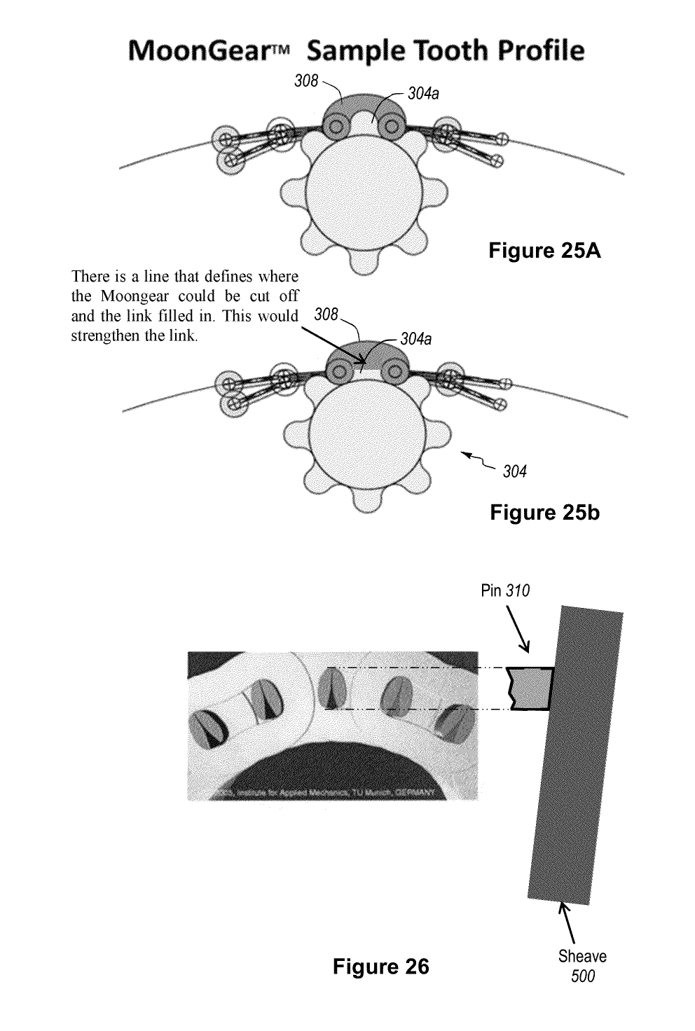

Turning now to FIGS. 25a, 25b, and 26-27, further details are provided concerning some example embodiments of a moon gear, one example of which is denoted at 304. As indicated there, a sample moon gear 304 tooth profile that accommodates the engagement of the various arcs of the chain 300. This illustration is representative of a 30 to 80 link change in circumference. As best shown in FIGS. 25a and 25b, the tooth 304a of the sprocket, or moon gear 304, could be nearly flat extending across the tooth 304a just above the line which runs from link pin to link pin and the rounded portion of the link 308 would be lowered to match it. This would provide a stronger link with less material.

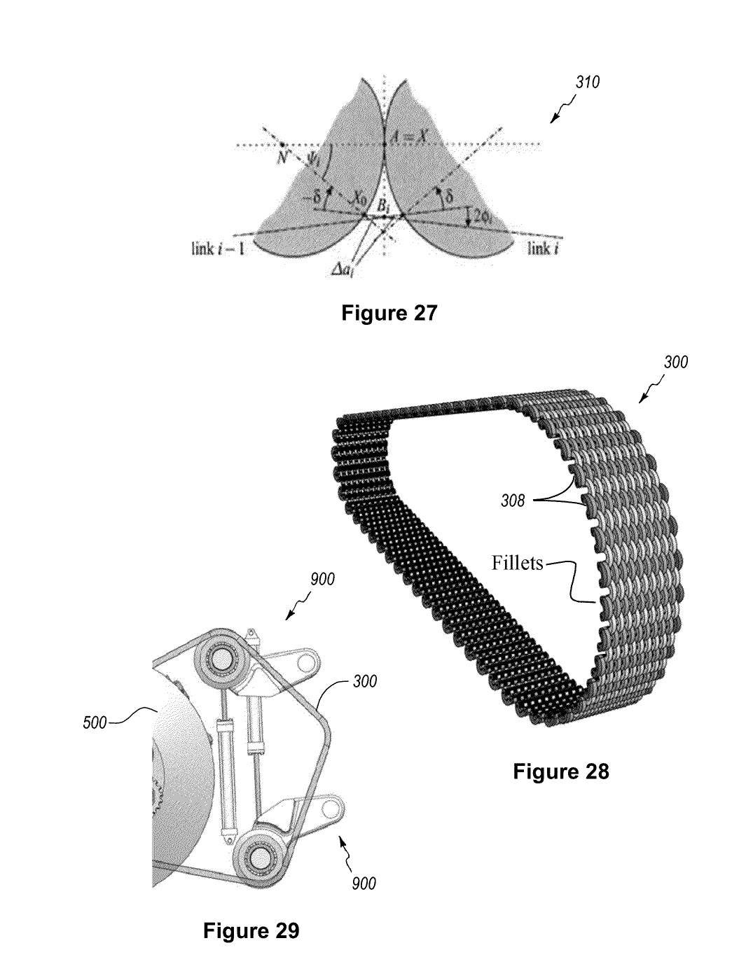

With reference now to FIGS. 26 and 27, the chain pin 310 used in the transmission 600 is called a split or rocker pin. It is this feature that extends the useful life of the chain by reducing chain stretch. It is locked in place along the outside edge of the chain pin 310. A keeper, such as a “C” ring, is used to keep the wafers of the chain 300 in place. As shown in FIG. 27, a side view of the chain pin 310 shows that it is beveled on its end to match the angle of the sheave 500. It is upon these ends that the sheave 500 supports the chain 300.

Turning now to FIGS. 28 and 29, details are provided concerning an example chain 300 and related components. As noted herein, and shown in FIG. 28, the chain 300 can be implemented in a belt configuration. In the illustrated example, a chain 300 in the form of a metal belt includes fillets to receive the teeth 304a of the moon gears 304. Unlike traditional CVTs that rely upon friction to transfer torque from the sheave to a belt, at least some embodiments of the invention are implemented as a positively displaced CVT that transfers torque by means of a moon gear 304 engagement, as disclosed herein. The primary purpose of the sheave 500 is to form the chain 300 into discrete circles, as disclosed elsewhere herein. Advantageously, in some embodiments, the sheave 500 clamping force (axial pressure) to maintain a belt in a circle is ⅓ of that needed when the objective is to transfer torque as in the case of a conventional CVT. In general, the higher the clamping force, the higher the inefficiency. With continued reference to FIG. 27, and reference as well to FIG. 28, one or more tensioners 900 can be used to modify the path taken by the chain 300 and to adjust and maintain the tension in the chain 300. One or more tensioners 900 can be employed on the input side of the transmission 600 and/or on the output side of the transmission 600.

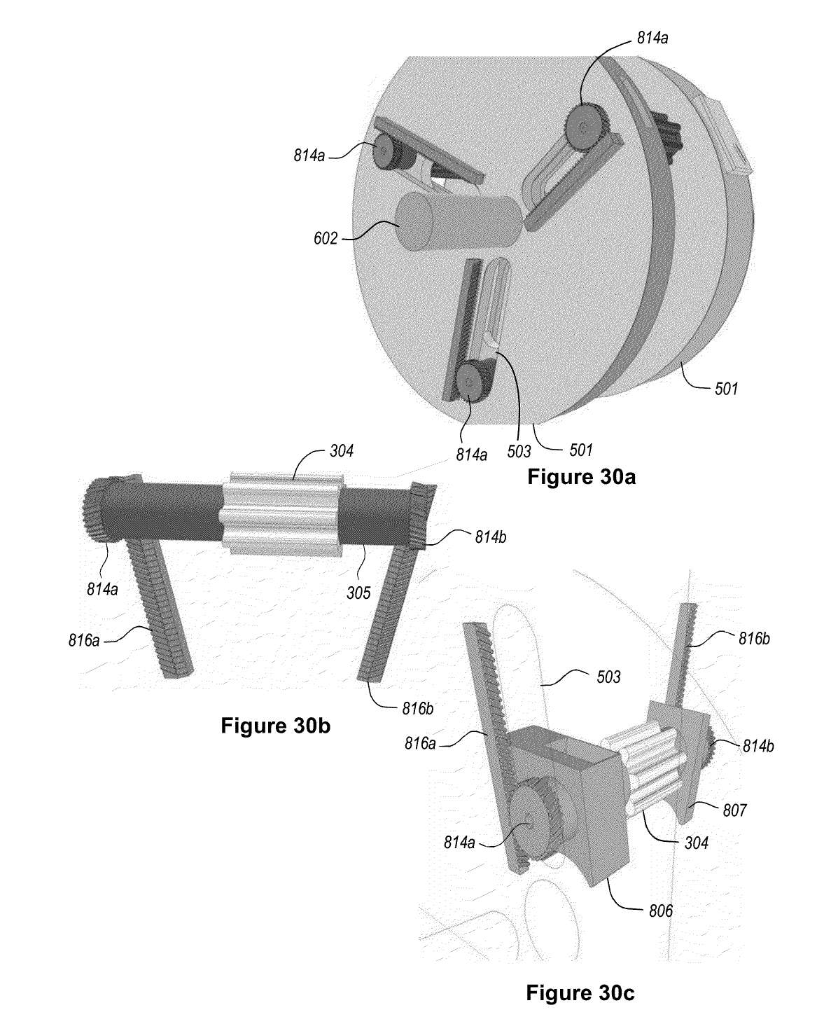

Directing renewed attention to FIGS. 22 and 23, and now to FIGS. 30a, 30b and 30c as well, further details are provided concerning the example sled assemblies 800 and related components and operations. More specifically, to assist the sleds 806 and 807 in their radial movement relative to the input shaft 602, the shaft 305 upon which the moon gear 304 is mounted can include a tracking gear 814 disposed at or near each end. The tracking gears 814 engage respective racks 816 located on the surface of the sheave halves 501. As the primary tracking gear 814a rides up the primary rack 816a, the primary tracking gear 814a forces the secondary tracking gear 814b to climb up the secondary rack 816b. This configuration and arrangement enables the two sleds 806 to move in and out in unison, and also provides a positive engagement with the sheave halves 501 so as to prevent slippage or other undesired motion.

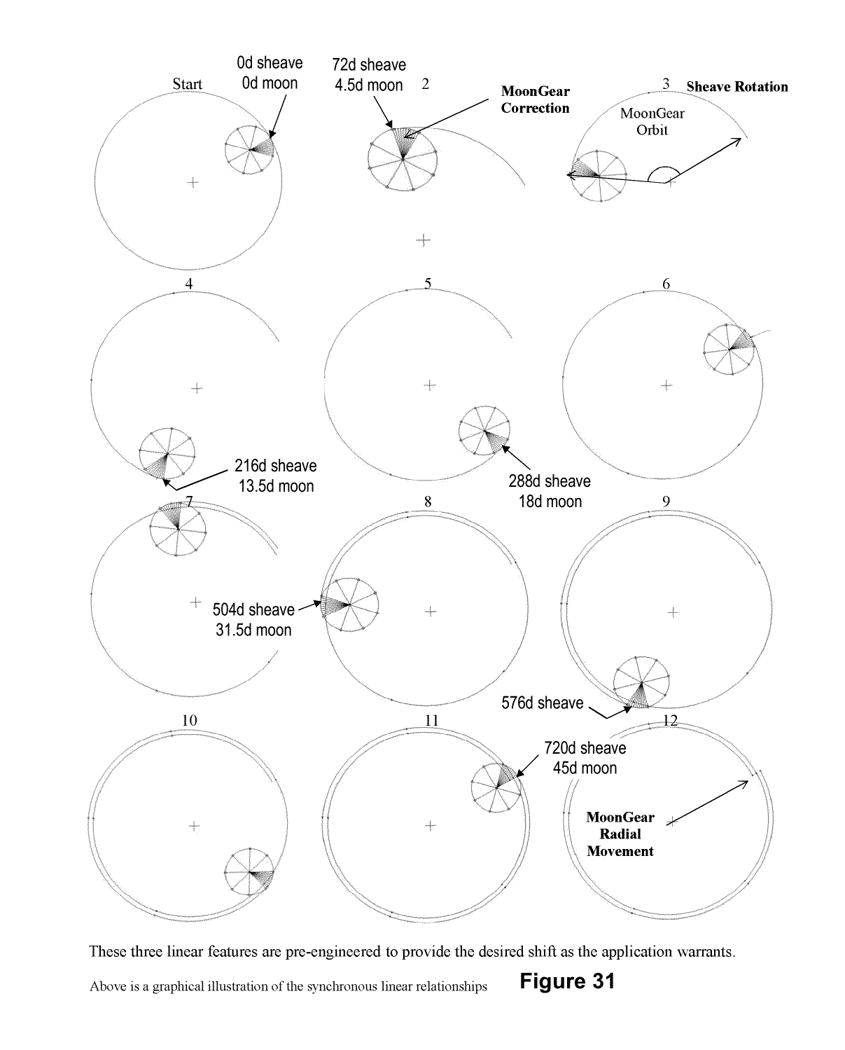

With reference briefly to FIG. 31, an example shift sequence is disclosed. In general, the three linear features, namely, moon gear correction, sheave rotation, and moon gear radial movement can be used as inputs to drive the design process and thus provide the desired shift as the application warrants.

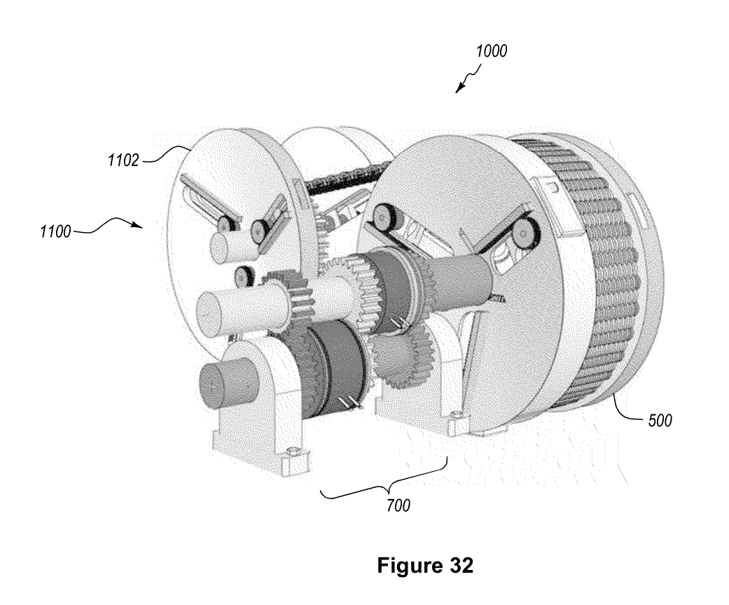

Turning finally to FIG. 32, details are provided concerning another embodiment of a transmission, denoted generally at 1000. Except as noted in the following discussion, the transmission 1000 may be similar, or identical, to the transmission 600. In general, one important distinction between the disclosed embodiments and conventional transmissions is the efficiency of operation in whole integers that is implemented in the disclosed embodiments. To further increase the ratio spread, a second variator 1100 with its own sheave 1102 and set of moon gears (not shown) can be used. Whole integers between two variators do not step in equal amounts. Therefore, each variator uses different lengths of chain. A tensioner (see FIG. 29) between the variator 1100 and that of the transmission 600 is needed to make up the difference.

It will be appreciated that various embodiments of the invention can be used in a number of different applications. These applications can generally involve a relatively constant input, or a variable input as in the case of a wind turbine application. In this particular example, one or more embodiments of the invention are considered as reactive in that because the wind, or input, can blow constantly and then change unpredictably, the moon gears must be prepared to synchronize under varying input wind conditions. While such embodiments operate in connection with a variable, or potentially variable input, their operation principles are quite similar to embodiments that use a constant input, with the exception of how the moon gears are indexed.

For example, the indexing of the moon gears may not occur for long periods of constant wind or constant input in non-whole integer circles, and then indexing must be performed to change to some unpredictable new ratio and continue to maintain synchronous engagement with the chain as the wind input varies. The adjustment of the moon gear for indexing is powered typically by servomotors, but could utilize hydraulics or other means. Yet other embodiments of the invention use tidal action, which can vary widely, as an input, and the same general notions that apply to a wind input would be applicable as well to a variable input such as the tide of an ocean or other body of water.

The variable input embodiments are controlled by computer driven algorithms that then initiate the indexing of the moon gears by servomotors. The controller provides engineering variables as to how fast the shift takes place. Turbine speed fluctuations will be fed into the computer to determine whether or not a shift needs to increase or decrease in speed. The radius of the moon gear orbit will also be monitored so that the computer can adjust the worm gear for synchronous engagement with the chain.

### Definition of Terms

Belt/Chain

The belt can be a composite or metal chain that has teeth on its inner surface.

Belt Stretch

A longer link changes the circumference and the radius of the whole integer circle. The moon will not be at TDC but it will comply.

Shift Controller

The shift controller provides torque from the input to power the indexer, and determines when a shift will occur, and how long the shift will take.

Indexer

The indexer takes the relative motion of the controller and coordinates the sheave separation, orbit radius and moon gear correction.

Indexing

As the moon gear travels through partial integer circles, during a shift, it must rotate or “Index” in order to maintain alignment with the chain.

Moon Gear

A moon gear is a gear which engages the teeth of the belt/chain of a continuously variable transmission (CVT). It orbits around the axis of the CVT sheaves. It also rotates on its own axis to correct for partial tooth engagements with the teeth of the belt/chain.

Moon Walk

When all moon gears are in a whole integer position, their teeth are lined up for synchronous engagement with the chain, but, also, they are all in the same identical position, such as top dead center. When a shift begins, or takes place, all of them begin to correct the same amount equal to the amount of the circumference increase. When the moon gears reach the next prime whole integer, they will have moved one full tooth or one full integer. But along the way they each walk equal amounts of correction. The difference between them is the degrees away from engagement that they are. So, a Moon Gear that is 240 degrees away has twice as much time to correct as one that is 120 degrees away. This can also be thought of not in terms of time, but in terms of angular rotation.

Non-Prime Circle

A non-prime (whole integer) circle occurs when only one link is added to a full circle. For example, a circle with 43 whole links or integers would be considered a non-prime circle because it is not divisible by three driving, or driven, members or moon gears. Such an arrangement will run in this position without needing to constantly index the moon gears, but it must initially correct or index moon gear #1 a third of a tooth, moon gear #2 two thirds of a tooth, and not index moon gear #3. When 44 whole links are employed, moon gear #1 must correct an additional third of a tooth to two thirds, moon gear #2 must correct to a whole tooth and moon gear #3 must correct to a third of a tooth.

Orbit

The moon gear travels in ever changing circular paths about the sheave axis. This is called the orbit of the moon gear and is defined by its distance from the sheave axis. It should not be confused with the moon gear rotation about its own axis.

Orbit Rotation

Orbital rotation refers to the number of degrees that a moon gear travels about the axis of a sheave. One full rotation of the sheave is equal to one full orbit of the moon gear, or 360°.

Partial Integer Circles

Any circle that is not a whole integer circle is a partial integer circle. In order to run in a partial integer circle, the moon gear must be constantly indexing. In at least some embodiments, the moon gear must index (rotate) in partial integer circles to correct for misalignment of the moon gear tooth and fillet of the chain. This is called partial integer correction and allows for proper tooth engagement.

Positively Displaced Continuously Variable Transmission (PDCVT)

This refers to advantageous characteristics of the disclosed embodiments whereby gears maintain constant engagement while moving through infinite increments of ratio change. This can be accomplished because teeth are cut into the inner surface of the belt or chain so that its unique moon gear can engage the belt in a positive manner.

Prime (whole integer) Circle

The prime circle is a whole integer circle which can be divided evenly by the number of driving members. That means that between each driving member there are an equal number of whole links or integers. For example, a whole integer circle with 42 whole links would be considered prime because it is divisible by three driving, or driven, members or moon gears.

Raking

Raking is a term used to describe the ripping apart of the teeth of the moon gear or raking across the teeth from the belt/chain during a shift.

Sheave Angle

Part of the formula of the controller is the angle of the sheave. The sheave angle can be modified within an efficiency range to manipulate the design for optimum performance.

Top Dead Center (TDC)

After a shift when all the moon gears reach the next desired whole integer orbit, all of the moon gears, must be in the same position. For purposes of this paper when the radial center of the moon gear tooth is in line with the orbital radius it is at (TDC).

Virtual Circles

In the typical CVT, virtual circles are an infinite number of theoretical circles formed by the belt when it travels inward and outward along the beveled surface of a sheave.

Whole Integer Circles

When a Moon Gear with a finite number of teeth are introduced into a mechanism with potentially an infinite number of virtual circles, a predictable number of those circles will engage with the moon gear perfectly, or nearly so. These circles are “whole integer circles.” The reason they are called whole integer is because the arc distance between the driving moon gear is equal to a whole number of links of the chain, so when running in a whole integer circle the moon gear does not need indexing. Even though the moon gear can index (rotate about its own axis) in thirds of a link for non-prime integers, this must be accomplished in one revolution. In some cases this could be very fast. It will run in this position without needing to constantly index the moon gear, but it must initially correct or index moon gear #1 a third of a tooth, moon gear #2 two thirds of a tooth and not index moon gear #3. This design scenario requires an additional ⅓ correction to each moon gear for every whole integer circle. It is the chain link length that determines the distance between whole integer circles, and also determines the size of the moon gear teeth.

Although this disclosure has been described in terms of certain embodiments, other embodiments apparent to those of ordinary skill in the art are also within the scope of this disclosure. Accordingly, the scope of the disclosure is intended to be defined only by the claims which follow.

What is claimed is:

1. A portion of a transmission, comprising:
first and second sheave halves disposed on a shaft, one of the sheave halves being movable along the shaft relative to the other sheave half;
two or more moon gears, each of the moon gears disposed on a rotatable shaft that is attached to a first sled that engages, and is slidable along, a slot defined in one of the sheave halves;
two or more moon indexer gears, each moon indexer gear attached to an upper end of one of the rotatable shafts, and each moon indexer gear residing in a respective second sled;
two or more shafts, each of the shafts having a worm gear mounted thereon that is configured to engage a respective moon indexer gear, and each shaft threadingly engaged with a corresponding second sled,
wherein in operation, rotation of the shaft causes a corresponding movement of the second sled that, in turn, effects movement of the first sheave half relative to the second sheave half and also effects a change in radial position of the associated moon gear, and rotation of the shaft also causes a corresponding indexing rotation of an associated moon gear.

2. The portion of the transmission as recited in claim 1, further comprising a differential operably coupled to the shafts and operable to effect rotation of the shafts.

3. The portion of the transmission as recited in claim 2, further comprising a reduction gear with which the differential and shafts are operably engaged.

4. The portion of the transmission as recited in claim 2, further comprising first and second gun locks, each of which is operable to temporarily stop rotation of a respective side gear of the differential.

5. The portion of the transmission as recited in claim 4, further comprising a first and second solenoid, each of which is operably connected with a respective gun lock.

6. The portion of the transmission as recited in claim 2, wherein the differential comprises a plurality of spider gears, each of which is rotatable about its own axis and about the shaft, and the differential further comprises first and second side gears, each of which engages the spider gears.

7. The portion of the transmission as recited in claim 1, wherein in operation, rotation of the shaft causes synchronous performance of any one or more of the following:
the corresponding movement of the second sled;
the movement of the first sheave half relative to the second sheave half;
the change in radial position of the associated moon gear; and
the corresponding indexing rotation of an associated moon gear.

8. The portion of the transmission as recited in claim 2, wherein the differential is operably coupled to the shaft by way of respective gears carried by the shafts.

9. A transmission including the portion of the transmission recited in claim 1.

10. A drive train including the transmission of claim 9 and comprising a prime mover operably engaged with the transmission.

11. A vehicle including the drive train of claim 10.

12. A portion of a transmission, comprising:
first and second sheave halves disposed on a shaft, one of the sheave halves being movable along the shaft relative to the other sheave half;
two or more moon gears, each of the moon gears disposed on a rotatable shaft that is attached to a first sled that engages, and is slidable along, a slot defined in one of the sheave halves;
an input shaft connected to the sheave halves and including a control gear;
a plurality of threaded shafts, each threaded shaft having a worm gear mounted thereto, the worm gear configured to engage an index gear of a respective rotatable shaft on which a respective one of the moon gears is mounted, and each threaded shaft including a threaded shaft drive gear that is configured to engage the control gear; and
a controller coupled to one or both of the input shaft and the threaded shaft drive gears, the controller operable to create a difference in rotational speed between the input shaft and the threaded shaft drive gear.

13. The portion of a transmission as recited in claim 12, wherein each indexer gear resides in a respective sled.

14. The portion of a transmission as recited in claim 12, wherein in operation, rotation of the threaded shafts causes a corresponding movement of the sled that, in turn, effects movement of the first sheave half relative to the second sheave half and also effects a change in radial position of the associated moon gear, and rotation of the threaded shafts also causes a corresponding indexing rotation of an associated moon gear.

15. The portion of the transmission as recited in claim 12, wherein the controller comprises:
a controller shaft;
a shifting solenoid mounted to the controller shaft; and
first, second and third gears mounted to the controller shaft and configured to engage respective first and second gears mounted to the input shaft and a third gear mounted to a shift shaft that is coupled with the input shaft.

16. A transmission including the portion of the transmission recited in claim 12.

17. A drive train including the transmission of claim 16, and comprising a prime mover operably engaged with the transmission.

18. A vehicle including the drive train of claim 17.
